(19) United States
(12) Patent Application Publication
(10) Pub. No.: US 2026/0360295 A1
(43) Pub. Date: Nov. 12, 2026

(54) DISPLAY DEVICE AND ELECTRONIC DEVICE INCLUDING SAME

(71) Applicant: Samsung Display Co., Ltd., Yongin-Si (KR)

(72) Inventors: KYUNGSU LEE, Yongin-si (KR); JONG-WOONG PARK, Yongin-si (KR); KUK-HWAN AHN, Yongin-si (KR); DAE-GWANG JANG, Yongin-si (KR)

(21) Appl. No.: 19/466,508

(22) Filed: Feb. 2, 2026

(30) Foreign Application Priority Data
May 7, 2025 (KR) 10-2025-0058777

(51) Int. Cl. G09G 3/20; G09G 3/3233

(52) U.S. Cl. CPC G09G 3/2044; G09G 3/2092; G09G 3/3233; G09G 2300/0452; G09G 2300/0842; G09G 2310/0297; G09G 2310/08; G09G 2320/0233

(57) ABSTRACT

A display device includes a display panel, a data driver, a gate driver, a demultiplexer, and a driving controller. The demultiplexer includes a first switching element configured to connect a first data line to an output channel of the data driver in response to a first switching signal and a second switching element configured to connect a second data line to the output channel in response to a second switching signal. The driving controller is configured to compensate for input image data based on a dithering map having a first reference grayscale less than an input grayscale or a second reference grayscale greater than the input grayscale for each of the first to fourth pixels. The dithering map is compensated for according to a non-overlapping period of a turn-on period of a switching signal and a turn-on period of a gate signal for each of first to fourth pixels.

This application claims priority under 35 USC § 119 to Korean Patent Application No. 10-2025-0058777 filed on May 7, 2025 in the Korean Intellectual Property Office (KIPO), the entire disclosure of which is incorporated by reference herein.

### BACKGROUND

### 1. Field

Embodiments of the present inventive concept relates to a display device and an electronic device including the same. More particularly, embodiments of the present inventive concept relate to a display device and an electronic device including the same for improving a display quality.

### 2. Description of the Related Art

In general, a display device includes a display panel and a display panel driver. The display panel includes gate lines, data lines, and pixels. The display panel driver includes a gate driver for providing a gate signal to the gate lines, a data driver for providing a data voltage to the data lines, and a driving controller for controlling the gate driver and the data driver.

The data driver may include output channels and provide the data voltage to the data lines through the output channels. The display device may further include a demultiplexer. The data driver may use the demultiplexer to reduce a number of the output channels. Specifically, when the data driver uses the demultiplexer, one output channel may be selectively connected to at least two data lines.

### SUMMARY

Embodiments of the present inventive concept provide a display device for maintaining a display quality when including a demultiplexer and performing a dithering operation.

Embodiments of the present inventive concept provide an electronic device including the display device.

In an embodiment of a display device according to the present inventive concept, the display device comprises a display panel including a first pixel connected to a first data line and a first gate line, a second pixel connected to the first data line and a second gate line, a third pixel connected to a second data line and the first gate line, and a fourth pixel connected to the second data line and the second gate line, a data driver including an output channel providing a data voltage to each of the first data line and the second data line, a gate driver configured to provide a first gate signal to the first gate line and a second gate signal to the second gate line, a demultiplexer including a first switching element configured to connect the first data line and the output channel in response to a first switching signal and a second switching element configured to connect the second data line and the output channel in response to a second switching signal, and a driving controller configured to control the data driver, the gate driver, and the demultiplexer, and configured to compensate for input image data based on a dithering map having a first reference grayscale less than an input grayscale or a second reference grayscale greater than the input grayscale for each of the first to fourth pixels. The driving controller is configured to compensate for the input image data based on the dithering map which is compensated for according to a non-overlapping period of a turn-on period of a switching signal and a turn-on period of a gate signal for each of the first to fourth pixels.

In an embodiment, a luminance of each of the first to fourth pixels may be different according to a time length of the non-overlapping period.

In an embodiment, as the time length of the non-overlapping period is long, the luminance of each of the first to fourth pixels may decrease.

In an embodiment, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller may be configured to increase a reference grayscale of the first pixel and a reference grayscale of the second pixel.

In an embodiment, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller may be configured to increase a reference grayscale of the first pixel and a reference grayscale of the fourth pixel.

In an embodiment, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller may be configured to select the dithering map, thereby selecting a selected dithering map, such that that a ratio of a number of pixels having the second reference grayscale in the first pixel and the third pixel becomes a target ratio. The driving controller may be configured to compensate for the input image data based on the selected dithering map.

In an embodiment, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller may be configured to select the dithering map, thereby selecting a selected dithering map, such that a ratio of a number of pixels having the second reference grayscale in the first pixel and the fourth pixel becomes a target ratio. The driving controller may be configured to compensate for the input image data based on the selected dithering map.

In an embodiment, the driving controller may be configured to compensate for the input image data based on a dithering map which changes during a plurality of frames.

In an embodiment, when the input grayscale is less than a threshold grayscale, the driving controller may be configured to compensate for the input image data based on the dithering map which changes during the plurality of frames.

In an embodiment, in a turn-on period of the first switching signal, the data voltage output from the output channel may be provided to the first data line.

In an embodiment, in a turn-on period of the first gate signal, the data voltage of the first data line may be provided to the first pixel, and in a turn-on period of the second gate signal, the data voltage of the first data line may be provided to the second pixel.

In an embodiment, in a turn-on period of the second switching signal, the data voltage output from the output channel may be provided to the second data line.

In an embodiment, in a turn-on period of the first gate signal, the data voltage of the second data line may be provided to the third pixel, and in a turn-on period of the second gate signal, the data voltage of the second data line may be provided to the fourth pixel.

In an embodiment, the display panel may further include a fifth pixel connected to a third data line and the first gate line and a sixth pixel connected to the third data line and the second gate line. The output channel may be configured to provide the data voltage to the third data line. The demultiplexer may further include a third switching element configured to connect the third data line and the output channel in response to a third switching signal. The driving controller may be configured to compensate for the dithering map based on the non-overlapping period for each of the first to sixth pixels.

In an embodiment, each of the first to fourth pixels may include a first color sub-pixel, a second color sub-pixel, and a third color sub-pixel.

In an embodiment of an electronic device according to the present inventive concept, the electronic device comprises a display panel including a first pixel connected to a first data line and a first gate line, a second pixel connected to the first data line and a second gate line, a third pixel connected to a second data line and the first gate line, and a fourth pixel connected to the second data line and the second gate line, a data driver including an output channel providing a data voltage to each of the first data line and the second data line, a gate driver configured to provide a first gate signal to the first gate line and a second gate signal to the second gate line, a demultiplexer including a first switching element configured to connect the first data line and the output channel in response to a first switching signal and a second switching element configured to connect the second data line and the output channel in response to a second switching signal, a driving controller configured to control the data driver, the gate driver, and the demultiplexer, and configured to compensate for input image data based on a dithering map having a first reference grayscale less than an input grayscale or a second reference grayscale greater than the input grayscale for each of the first to fourth pixels, and a processor configured to control the driving controller. The driving controller is configured to compensate for the input image data based on the dithering map which is compensated for according to a non-overlapping period of a turn-on period of a switching signal and a turn-on period of a gate signal for each of the first to fourth pixels.

In an embodiment, a luminance of each of the first to fourth pixels may be different according to a time length of the non-overlapping period.

In an embodiment, as the time length of the non-overlapping period is long, the luminance of each of the first to fourth pixels may decrease.

In an embodiment, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller may be configured to increase a reference grayscale of the first pixel and a reference grayscale of the second pixel.

In an embodiment, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller may be configured to increase a reference grayscale of the first pixel and a reference grayscale of the fourth pixel.

According to the display device and the electronic device, the driving controller may compensate for the input image data based on the dithering map compensated for according to the non-overlapping period of the turn-on period of the switching signal and the turn-on period of the gate signal among the turn-on period of the gate signal for each pixel. Accordingly, even if the display device includes the demultiplexer and performs the temporal spatial dithering, the luminance of the unit area may be constant, and the display quality may be constant.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to embodiments of the present inventive concept;

FIG. 2 is a circuit diagram showing an example of a pixel of a display panel of FIG. 1;

FIGS. 3 and FIG. 4 are circuit diagrams showing pixels included in a same pixel row, a demultiplexer connected to the pixels, and an output channel connected to the demultiplexer of FIG. 1;

FIG. 5 is a timing diagram showing a gate-source voltage according to a data write gate signal, a switching signal, and a data voltage of FIG. 3;

FIG. 6 is a circuit diagram showing an operation of pixels, a demultiplexer, and an output channel of FIG. 3 in a first period of FIG. 5;

FIG. 7 is a circuit diagram showing an operation of pixels, a demultiplexer, and an output channel of FIG. 3 in a second period of FIG. 5;

FIG. 8 is a circuit diagram showing an operation of pixels, a demultiplexer, and an output channel of FIG. 3 in a third period of FIG. 5;

FIG. 9 is a circuit diagram showing an operation of pixels, a demultiplexer, and an output channel of FIG. 3 in a fourth period of FIG. 5;

FIG. 10 and FIG. 11 are timing diagrams showing a non-overlapping period according to a data write gate signal and a switching signal of FIG. 5;

FIG. 12 is a circuit diagram showing a luminance of pixels of FIG. 3 according to a driving method of FIGS. 10 and FIG. 11;

FIGS. 13 and FIG. 14 are timing diagrams showing a non-overlapping period according to a data write gate signal and a switching signal of FIG. 5;

FIG. 15 is a circuit diagram showing a luminance of pixels of FIG. 3 according to a driving method of FIGS. 13 and FIG. 14;

FIG. 16 is a conceptual diagram showing a temporal dithering;

FIG. 17 is a conceptual diagram showing a spatial dithering;

FIG. 18 is a conceptual diagram showing a temporal spatial dithering;

FIG. 19 is a diagram showing an input grayscale of each of unit areas and pixels included in each of the unit areas;

FIG. 20 is a diagram showing a dithering map used for a temporal spatial dithering;

FIG. 21 is a circuit diagram showing pixels included in a unit area, a demultiplexer connected to the pixels, and an output channel connected to the demultiplexer;

FIG. 22 is a timing diagram showing a first driving method of a demultiplexer;

FIG. 23 is a circuit diagram showing a luminance of pixels of FIG. 21 in a driving method of FIG. 22;

FIG. 24 is a diagram showing an example of a compensation dithering map which compensates for a luminance of pixels of FIG. 21 in a driving method of FIG. 22;

FIG. 25 is a diagram showing another example of a compensation dithering map which compensates for a luminance of pixels of FIG. 21 in a driving method of FIG. 22;

FIG. 26 is a timing diagram showing a second driving method of a demultiplexer;

FIG. 27 is a circuit diagram showing a luminance of pixels of FIG. 21 in a driving method of FIG. 26;

FIG. 28 is a diagram showing an example of a compensation dithering map which compensates for a luminance of pixels of FIG. 21 in a driving method of FIG. 26;

FIG. 29 is a diagram showing another example of a compensation dithering map which compensates for a luminance of pixels of FIG. 21 in a driving method of FIG. 26;

FIGS. 30 and FIG. 31 are circuit diagrams showing pixels included in a same pixel row, a demultiplexer connected to the pixels, and an output channel connected to the demultiplexer of FIG. 1;

FIG. 32 is a timing diagram showing a non-overlapping period according to a data write gate signal and a switching signal of FIG. 30;

FIG. 33 is a circuit diagram showing pixels included in a unit area, a demultiplexer connected to the pixels, and an output channel connected to the demultiplexer;

FIG. 34 is a circuit diagram showing an example of a pixel of a display panel of FIG. 1;

FIG. 35 is a timing diagram showing an example of an operation of a pixel of FIG. 34;

FIG. 36 is a circuit diagram showing an operation of a pixel of FIG. 34 in an initialization period of FIG. 35;

FIG. 37 is a circuit diagram showing an operation of a pixel of FIG. 34 in a data write period of FIG. 35;

FIG. 38 is a circuit diagram showing an operation of a pixel of FIG. 34 in a light emission period of FIG. 35;

FIG. 39 is a circuit diagram showing pixels included in a same pixel row, a demultiplexer connected to the pixels, and an output channel connected to the demultiplexer of FIG. 1;

FIG. 40 is a block diagram showing an electronic device according to an embodiment of the present inventive concept;

FIG. 41 is a diagram showing an example in which an electronic device of FIG. 40 is implemented as a smart phone;

FIG. 42 is a block diagram showing an electronic device according to an embodiment of the present inventive concept; and

FIG. 43 is schematic diagrams showing electronic devices of FIG. 42.

### DETAILED DESCRIPTION OF THE EMBODIMENTS

Hereinafter, the present inventive concept will be described in more detail with reference to the accompanying drawings.

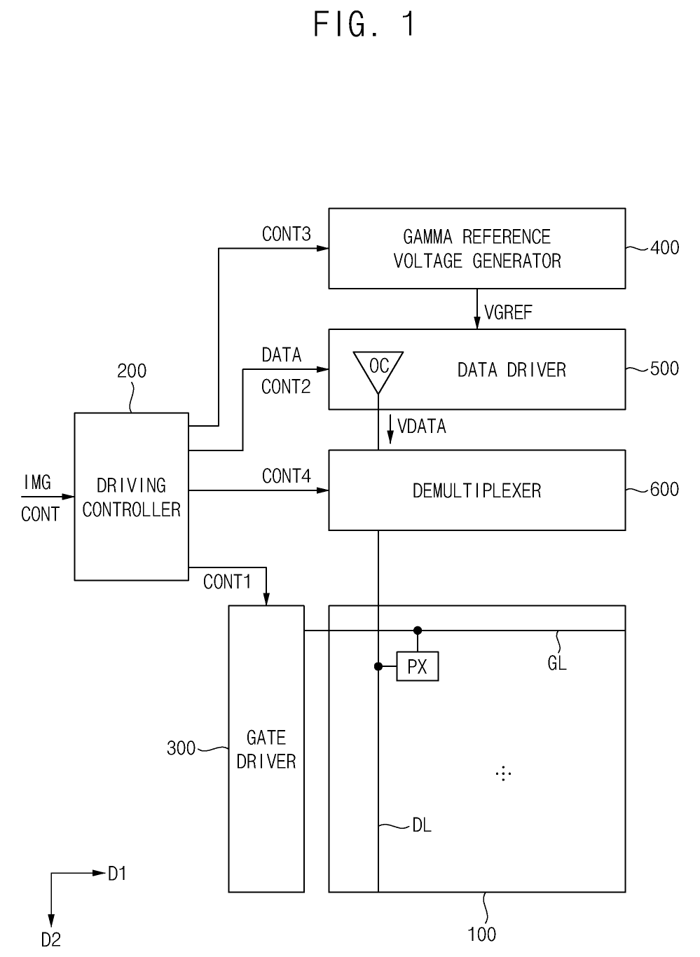

FIG. 1 is a block diagram showing a display device according to embodiments of the present inventive concept.

Referring to FIG. 1, a display device may include a display panel 100 and a display panel driver. The display panel driver may include a driving controller 200, a gate driver 300, a gamma reference voltage generator 400, and a data driver 500. The display panel driver may further include a demultiplexer 600.

For example, the driving controller 200 and the data driver 500 may be formed integrally. For example, the driving controller 200, the gamma reference voltage generator 400, and the data driver 500 may be formed integrally. For example, the driving controller 200, the gate driver 300, the gamma reference voltage generator 400, and the data driver 500 may be formed integrally. For example, the driving controller 200, the gate driver 300, the gamma reference voltage generator 400, the data driver 500, and the demultiplexer 600 may be formed integrally. Meanwhile, a driving module in which at least the driving controller 200 and the data driver 500 are formed integrally may be named a timing controller embedded data driver (TED).

The display panel 100 may include a display area for displaying an image and a peripheral area disposed adjacent to the display area.

For example, the display panel 100 may be an organic light emitting diode display panel including an organic light emitting diode. For another example, the display panel 100 may be a quantum-dot organic light emitting diode display panel including an organic light emitting diode and a quantum-dot color filter. For another example, the display panel 100 may be a quantum-dot nano light emitting diode display panel including a nano light emitting diode and a quantum-dot color filter. For another example, the display panel 100 may be a liquid crystal display panel including a liquid crystal layer.

The display panel 100 may include gate lines GL, data lines DL, and pixels PX electrically connected to the gate lines GL and the data lines DL, respectively. The gate lines GL may extend in a first direction D1 and the data lines DL may extend in a second direction D2 crossing the first direction D1.

The driving controller 200 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the demultiplexer 600 based on the input control signal CONT, and output the fourth control signal CONT4 to the demultiplexer 600.

The gate driver 300 may generate gate signals for driving the gate lines GL in response to the first control signal CONT1 received from the driving controller 200. The gate driver 300 may output the gate signals to the gate lines GL.

In an embodiment, the gate driver 300 may be integrated on the peripheral area of the display panel 100. In an embodiment, the gate driver 300 may be mounted into the peripheral area of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to the data signal DATA.

For example, the gamma reference voltage generator 400 may be disposed within the driving controller 200 or may be disposed within the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into an analog data voltage VDATA using the gamma reference voltage VGREF. The data driver 500 may include an output channel OC which outputs the data voltage VDATA and outputs the data voltage VDATA to the data line DL through the output channel OC.

In an embodiment, the data driver 500 may be integrated into the peripheral area of the display panel 100. In an embodiment, the data driver 500 may be mounted in the peripheral area of the display panel 100.

The demultiplexer 600 may include switching elements (not shown) and control the switching elements based on the fourth control signal CONT4 received from the driving controller 200. The demultiplexer 600 may control the switching elements to selectively connect the output channel OC to each of the data lines DL.

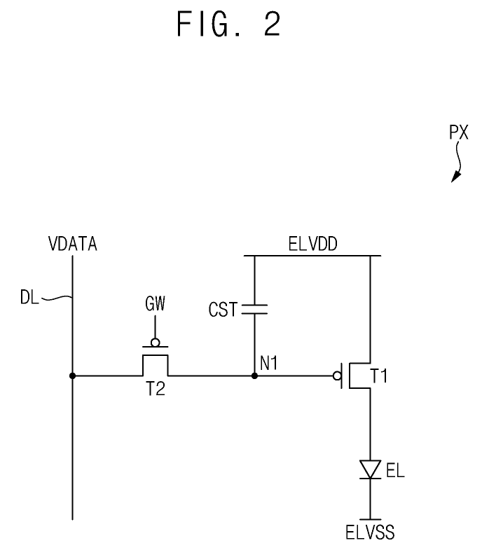

FIG. 2 is a circuit diagram showing an example of a pixel PX of a display panel 100 of FIG. 1.

Referring to FIGS. 1 and 2, a pixel PX may include a first transistor T1, a second transistor T2, a storage capacitor CST, and a light emitting element EL.

In an embodiment, the first transistor T1 and the second transistor T2 may be P-type transistors. For example, the P-type transistor may be a PMOS transistor.

The PMOS transistor may be turned on when a gate-source voltage of the PMOS transistor is less than or equal to a threshold voltage (e.g., a negative value) of the PMOS transistor. On the other hand, the PMOS transistor may be turned off when the gate-source voltage of the PMOS transistor is greater than the threshold voltage of the PMOS transistor. For example, when a gate signal having a low level is applied to a gate electrode of the PMOS transistor, the PMOS transistor may be turned on. For example, when a gate signal having a high level is applied to the gate electrode of the PMOS transistor, the PMOS transistor may be turned off. Here, the low level may be a turn-on level of the PMOS transistor, and the high level may be a turn-off level of the PMOS transistor.

The first transistor T1 may include a gate electrode connected to a first node N1, a first electrode receiving a first power supply voltage ELVDD, and a second electrode. The first transistor T1 may be turned on based on a voltage of the first node N1 and the first power supply voltage ELVDD to generate a driving current. Specifically, the first transistor T1 may generate the driving current based on a difference between the voltage of the first node N1 and the first power supply voltage ELVDD. Therefore, as the difference between the voltage of the first node N1 and the first power supply voltage ELVDD is large, a magnitude of the driving current may be large. For example, the first transistor T1 may be referred to as a driving transistor.

The second transistor T2 may include a gate electrode receiving a data write gate signal GW, a first electrode connected to a data line DL transmitting a data voltage VDATA, and a second electrode connected to the first node N1. The second transistor T2 may be turned on in response to a data write gate signal GW having the turn-on level to provide the data voltage VDATA to the first node N1. For example, the second transistor T2 may be referred to as a data write transistor.

The storage capacitor CST may include a first electrode receiving the first power supply voltage ELVDD and a second electrode connected to the first node N1. The storage capacitor CST may store the data voltage VDATA provided to the first node N1.

The light emitting element EL may include an anode electrode connected to the second electrode of the first transistor T1 and a cathode electrode receiving a second power supply voltage ELVSS. The light emitting element EL may emit a light based on the driving current. As the magnitude of the driving current is large, a luminance corresponding to a light emission intensity of the light emitting element EL may be large.

In FIG. 2, the pixel PX is shown as including two transistors and one capacitor, but the present inventive concept is not limited thereto. The pixel PX of the present inventive concept may include at least three transistors or at least two capacitors.

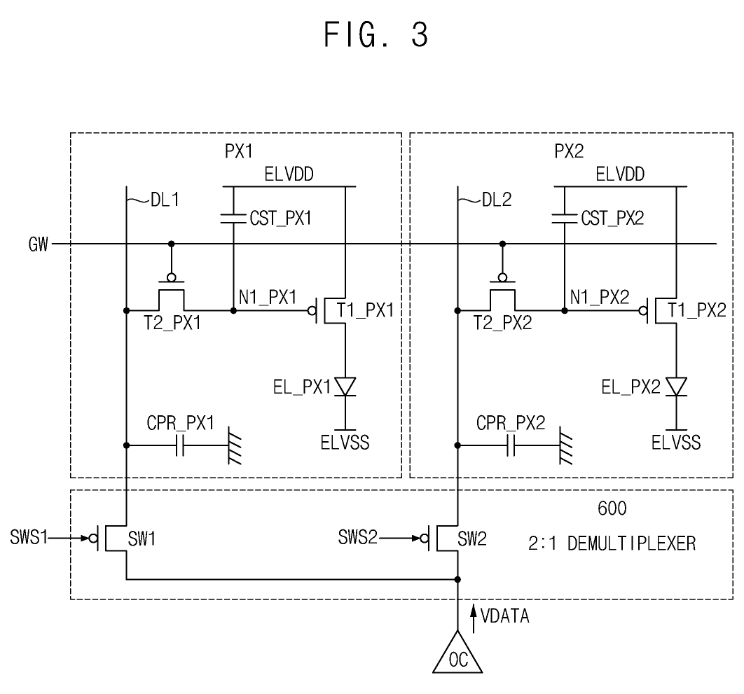

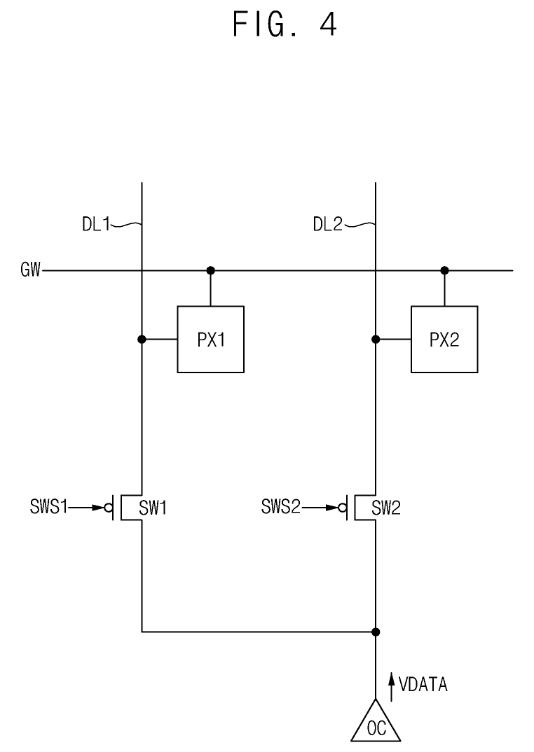

FIGS. 3 and FIG. 4 are circuit diagrams showing pixels PX1, PX2 included in a same pixel row, a demultiplexer 600 connected to the pixels PX1, PX2, and an output channel OC connected to the demultiplexer 600 of FIG. 1.

Referring to FIGS. 1-4, a same pixel row may include a plurality of pixels PX1, PX2. For example, the same pixel row may include a first pixel PX1 and a second pixel PX2. The first pixel PX1 and the second pixel PX2 may be disposed adjacent to each other. FIGS. 3 and 4 show that the same pixel row includes two pixels PX1, PX2, but the present inventive concept is not limited thereto.

The first pixel PX1 may include a first transistor T1_PX1, a second transistor T2_PX1, a storage capacitor CST_PX1, and a light emitting element EL_PX1. The first transistor T1_PX1 may include a gate electrode connected to a first node N1_PX1, a first electrode receiving a first power supply voltage ELVDD, and a second electrode. The second transistor T2_PX1 may include a gate electrode receiving a data write gate signal GW, a first electrode connected to a first data line DL1, and a second electrode connected to the first node N1_PX1. The storage capacitor CST_PX1 may include a first electrode receiving the first power supply voltage ELVDD and a second electrode connected to the first node N1_PX1. The light emitting element EL_PX1 may include an anode electrode connected to the second electrode of the first transistor T1_PX1 and a cathode electrode receiving a second power supply voltage ELVSS. The first pixel PX1 may further include a parasitic capacitor CPR_PX1. The parasitic capacitor CPR_PX1 may be connected to the first data line DL1.

The second pixel PX2 may include a first transistor T1_PX2, a second transistor T2_PX2, a storage capacitor CST_PX2, and a light emitting element EL_PX2. The first transistor T1_PX2 may include a gate electrode connected to a first node N1_PX2, a first electrode receiving the first power supply voltage ELVDD, and a second electrode. The second transistor T2_PX2 may include a gate electrode receiving the data write gate signal GW, a first electrode connected to a second data line DL2, and a second electrode connected to the first node N1_PX2. The storage capacitor CST_PX2 may include a first electrode receiving the first power supply voltage ELVDD and a second electrode connected to the first node N1_PX2. The light emitting element EL_PX2 may include an anode electrode connected to the second electrode of the first transistor T1_PX2 and a cathode electrode receiving the second power supply voltage ELVSS. The second pixel PX2 may further include a parasitic capacitor CPR_PX2. The parasitic capacitor CPR_PX2 may be connected to the second data line DL2.

A demultiplexer 600 may selectively connect an output channel OC to each of the first data line DL1 and the second data line DL2. For example, the demultiplexer 600 may be a 2:1 demultiplexer and may include a first switching element SW1 and a second switching element SW2.

In an embodiment, the first switching element SW1 and the second switching element SW2 may be P-type transistors. For example, the P-type transistors may be PMOS transistors.

The first switching element SW1 may be turned on in response to a first switching signal SWS1 having the turn-on level to connect the output channel OC and the first data line DL1. The second switching element SW2 may be turned on in response to a second switching signal SWS2 having the turn-on level to connect the output channel OC and the second data line DL2.

The output channel OC may be connected to the first switching element SW1 and the second switching element SW2. The output channel OC may output a data voltage VDATA.

When the output channel OC outputs the data voltage VDATA and the first switching element SW1 is turned on in response to the first switching signal SWS1 having the turn-on level, the data voltage VDATA output from the output channel OC may be provided to the first data line DL1. When the data write gate signal GW has the turn-on level, the data voltage VDATA provided to the first data line DL1 may be provided to the first pixel PX1.

When the output channel OC outputs the data voltage VDATA and the second switching element SW2 is turned on in response to the second switching signal SWS2 having the turn-on level, the data voltage VDATA output from the output channel OC may be provided to the second data line DL2. When the data write gate signal GW has the turn-on level, the data voltage VDATA provided to the second data line DL2 may be provided to the second pixel PX2.

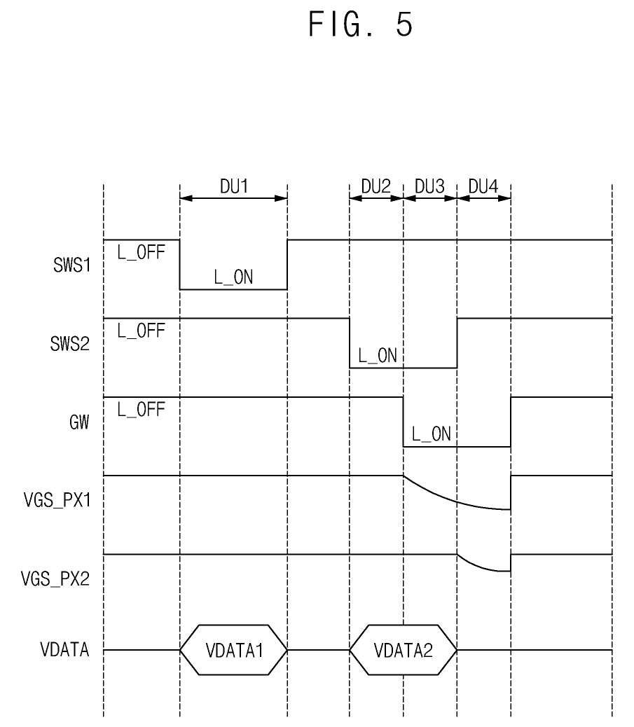

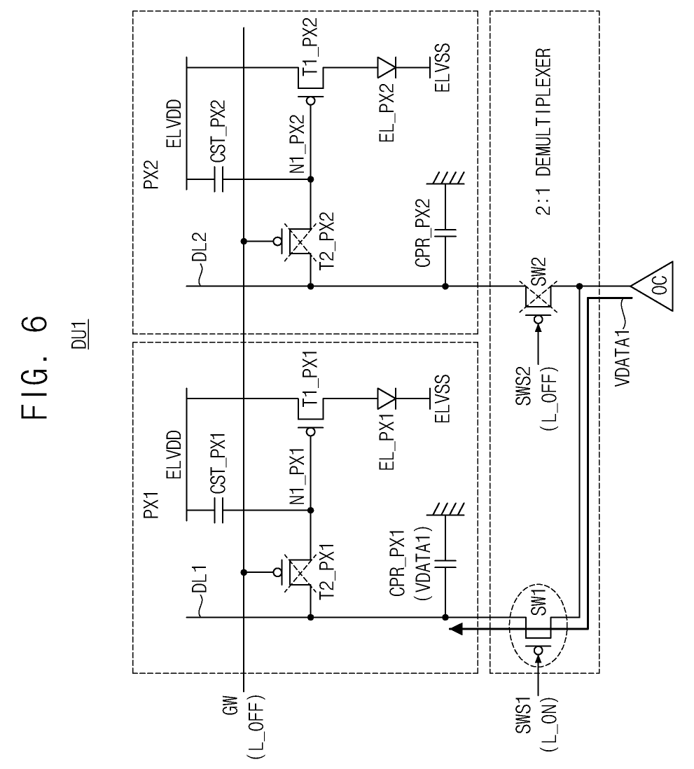

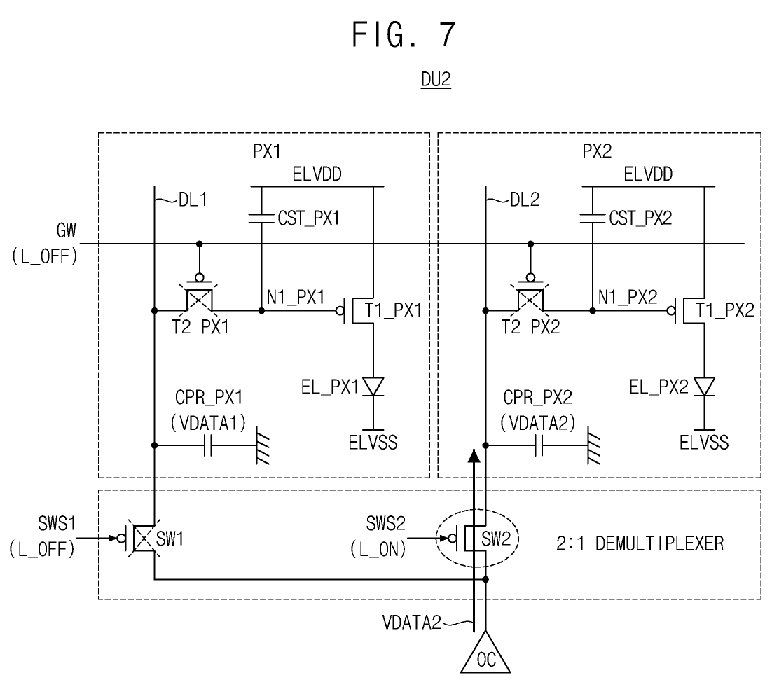

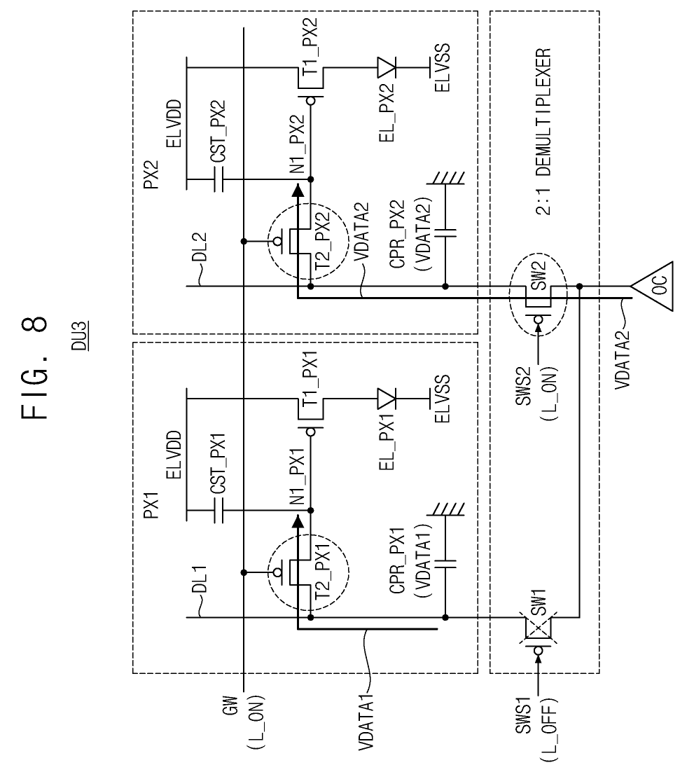

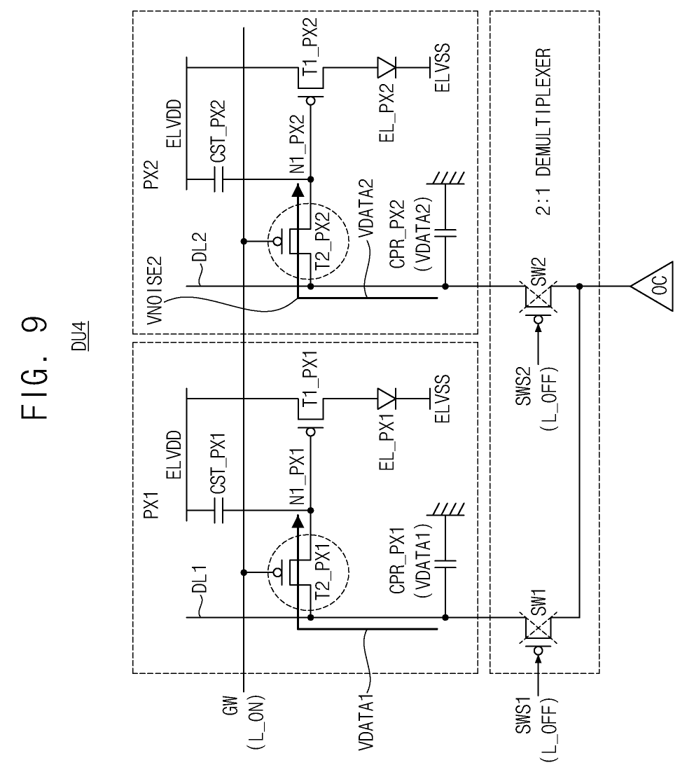

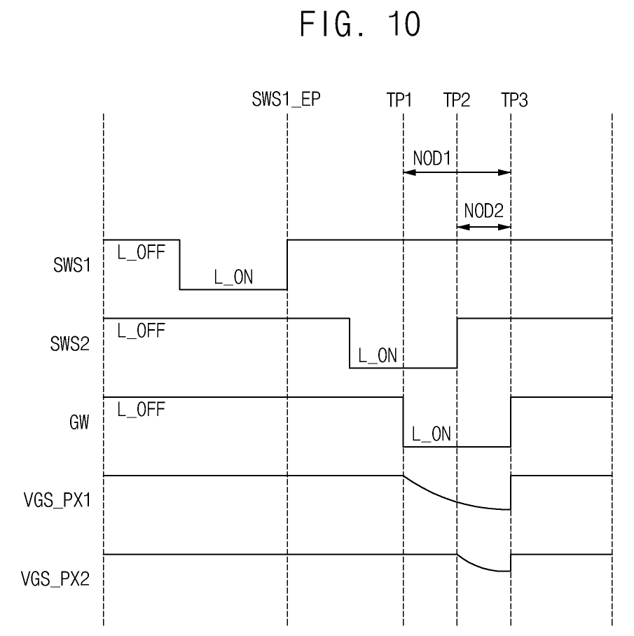

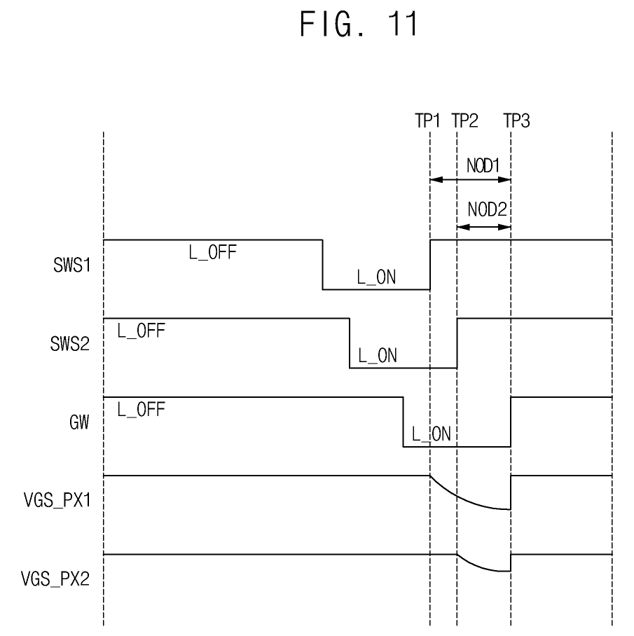

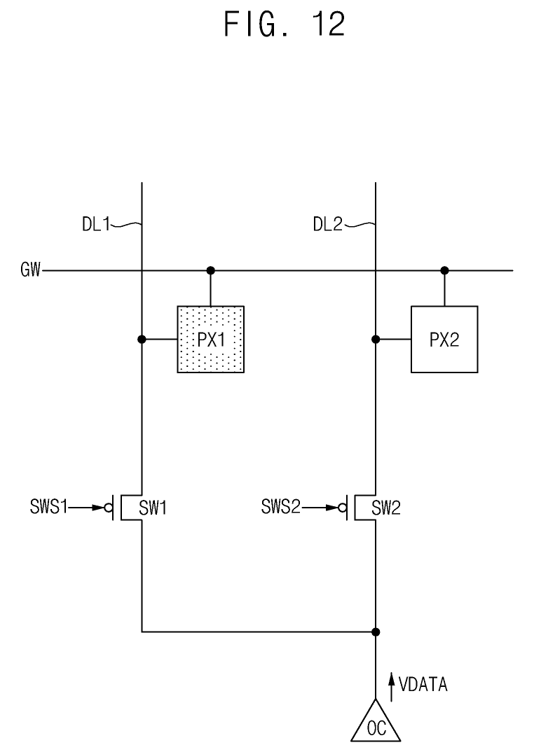

FIG. 5 is a timing diagram showing gate-source voltages VGS_PX1, VGS_PX2 according to a data write gate signal GW, switching signals SWS1, SWS2, and data voltages VDATA1, VDATA2 of FIG. 3. FIG. 6 is a circuit diagram showing an operation of pixels PX1, PX2, a demultiplexer 600, and an output channel OC of FIG. 3 in a first period DU1 of FIG. 5. FIG. 7 is a circuit diagram showing an operation of pixels PX1, PX2, a demultiplexer 600, and an output channel OC of FIG. 3 in a second period DU2 of FIG. 5. FIG. 8 is a circuit diagram showing an operation of pixels PX1, PX2, a demultiplexer 600, and an output channel OC of FIG. 3 in a third period DU3 of FIG. 5. FIG. 9 is a circuit diagram showing an operation of pixels PX1, PX2, a demultiplexer 600, and an output channel OC of FIG. 3 in a fourth period DU4 of FIG. 5. FIG. 10 and FIG. 11 are timing diagrams showing non-overlapping periods NOD1, NOD2 according to a data write gate signal GW and switching signals SWS1, SWS2 of FIG. 5. FIG. 12 is a circuit diagram showing a luminance of pixels PX1, PX2 of FIG. 3 according to a driving method of FIGS. 10 and FIG. 11.

Referring to FIGS. 1-12, the pixels PX1, PX2 included in the same pixel row, the switching elements SW1, SW2 included in the demultiplexer 600, and the output channel OC may operate in first to fourth periods DU1 to DU4. The first to fourth periods DU1 to DU4 may have a time length shorter than one frame.

In the first period DU1, the first switching signal SWS1 may have the turn-on level L_ON, the second switching signal SWS2 may have the turn-off level L_OFF, the data write gate signal GW may have the turn-off level L_OFF, and the data voltage VDATA may have a first data voltage VDATA1.

In the first period DU1, the output channel OC may output the first data voltage VDATA1. The first switching element SW1 may be turned on in response to the first switching signal SWS1 having the turn-on level L_ON to connect the output channel OC and the first data line DL1. The first data voltage VDATA1 output from the output channel OC may be provided to the first data line DL1. The second transistor T2_PX1 of the first pixel PX1 may be turned off in response to the data write gate signal GW having the turn-off level L_OFF. Therefore, the parasitic capacitor CPR_PX1 of the first pixel PX1 may store the first data voltage VDATA1 output from the output channel OC, and the first data voltage VDATA1 output from the output channel OC may not be provided to the first node N1_PX1 of the first pixel PX1.

In the first period DU1, the second switching element SW2 may be turned off in response to the second switching signal SWS2 having the turn-off level L_OFF. The first data voltage VDATA1 output from the output channel OC may not be provided to the second data line DL2.

In the second period DU2, the first switching signal SWS1 may have the turn-off level L_OFF, the second switching signal SWS2 may have the turn-on level L_ON, the data write gate signal GW may have the turn-off level L_OFF, and the data voltage VDATA may have a second data voltage VDATA2.

In the second period DU2, the output channel OC may output the second data voltage VDATA2. The first switching element SW1 may be turned off in response to the first switching signal SWS1 having the turn-off level L_OFF. Therefore, the second data voltage VDATA2 output from the output channel OC may not be provided to the first data line DL1.

In the second period DU2, the second switching element SW2 may be turned on in response to the second switching signal SWS2 having the turn-on level L_ON to connect the output channel OC and the second data line DL2. The second data voltage VDATA2 output from the output channel OC may be provided to the second data line DL2. The second transistor T2_PX2 of the second pixel PX2 may be turned off in response to the data write gate signal GW having the turn-off level L_OFF. Therefore, the parasitic capacitor CPR_PX2 of the second pixel PX2 may store the second data voltage VDATA2 output from the output channel OC, and the second data voltage VDATA2 output from the output channel OC may not be provided to the first node N1_PX2 of the second pixel PX2.

In the third period DU3, the first switching signal SWS1 may have the turn-off level L_OFF, the second switching signal SWS2 may have the turn-on level L_ON, the data write gate signal GW may have the turn-on level L_ON, and the data voltage VDATA may have the second data voltage VDATA2.

In the third period DU3, the output channel OC may output the second data voltage VDATA2. The first switching element SW1 may be turned off in response to the first switching signal SWS1 having the turn-off level L_OFF. The second data voltage VDATA2 output from the output channel OC may not be provided to the first data line DL1. The first data voltage VDATA1 stored in the parasitic capacitor CPR_PX1 of the first pixel PX1 may be provided to the first data line DL1. The parasitic capacitor CPR_PX1 of the first pixel PX1 may store and discharge charge by an electrostatic capacitance. Therefore, the parasitic capacitor CPR_PX1 of the first pixel PX1 may not continuously output the charge, and as the discharge continues, the first data voltage VDATA1 stored in the parasitic capacitor CPR_PX1 of the first pixel PX1 may continuously decrease. The second transistor T2_PX1 of the first pixel PX1 may be turned on in response to the data write gate signal GW having the turn-on level L_ON to provide the first data voltage VDATA1 stored in the parasitic capacitor CPR_PX1 of the first pixel PX1 to the first node N1_PX1 of the first pixel PX1. The first data voltage VDATA1 stored in the parasitic capacitor CPR_PX1 of the first pixel PX1 may be continuously decreased. Accordingly, a gate-source voltage VGS_PX1 of the first transistor T1_PX1 of the first pixel PX1 may be affected by a first data voltage VDATA1 which is stored in the parasitic capacitor CPR_PX1 of the first pixel PX1 and continuously decreases. For example, the gate-source voltage VGS_PX1 of the first transistor T1_PX1 of the first pixel PX1 may be stored in the parasitic capacitor CPR_PX1 of the first pixel PX1 and may decrease due to an influence of the continuously decreasing first data voltage VDATA1.

In the third period DU3, the second switching element SW2 may be turned on in response to the second switching signal SWS2 having the turn-on level L_ON to connect the output channel OC and the second data line DL2. The second data voltage VDATA2 output from the output channel OC may be provided to the second data line DL2. The parasitic capacitor CPR_PX2 of the second pixel PX2 may store and discharge a charge by an electrostatic capacitance. However, since the second data voltage VDATA2 output from the output channel OC is provided by a voltage source, a voltage of the second data line DL2 may be stably maintained by the second data voltage VDATA2 output from the output channel OC. The second transistor T2_PX2 of the second pixel PX2 is turned on in response to the data write gate signal GW having the turn-on level L_ON, such that a voltage of the second data line DL2 may be output from the output channel OC and provide the stably maintained second data voltage VDATA2 to the first node N1_PX2 of the second pixel PX2. Accordingly, a gate-source voltage VGS_PX2 of the first transistor T1_PX2 of the second pixel PX2 may be stably maintained.

In the fourth period DU4, the first switching signal SWS1 may have the turn-off level L_OFF, the second switching signal SWS2 may have the turn-off level L_OFF, and the data write gate signal GW may have the turn-on level L_ON.

In the fourth period DU4, the first switching element SW1 may be turned off in response to the first switching signal SWS1 having the turn-off level L_OFF. The first data voltage VDATA1 stored in the parasitic capacitor CPR_PX1 of the first pixel PX1 may be provided to the first data line DL1. The parasitic capacitor CPR_PX1 of the first pixel PX1 may store and discharge the charge by the electrostatic capacitance. Therefore, the parasitic capacitor CPR_PX1 of the first pixel PX1 may not continuously output the charge, and as the discharge continues, the first data voltage VDATA1 stored in the parasitic capacitor CPR_PX1 of the first pixel PX1 may continuously decrease. The second transistor T2_PX1 of the first pixel PX1 may be turned on in response to the data write gate signal GW having the turn-on level L_ON to provide the first data voltage VDATA1 stored in the parasitic capacitor CPR_PX1 of the first pixel PX1 to the first node N1_PX1 of the first pixel PX1. Accordingly, the gate-source voltage VGS_PX1 of the first transistor T1_PX1 of the first pixel PX1 may be affected by a first data voltage VDATA1 which is stored in the parasitic capacitor CPR_PX1 of the first pixel PX1 and continuously decreases. For example, the gate-source voltage VGS_PX1 of the first transistor T1_PX1 of the first pixel PX1 may further decrease due to the influence of the first data voltage VDATA1 which is stored in the parasitic capacitor CPR_PX1 of the first pixel PX1 and continuously decreases.

In the fourth period DU4, the second switching element SW2 may be turned off in response to the second switching signal SWS2 having the turn-off level L_OFF. The second data voltage VDATA2 stored in the parasitic capacitor CPR_PX2 of the second pixel PX2 may be provided to the second data line DL2. The parasitic capacitor CPR_PX2 of the second pixel PX2 may store and discharge the charge by the electrostatic capacitance. Therefore, the parasitic capacitor CPR_PX2 of the second pixel PX2 may not continuously output the charge, and as the discharge continues, the second data voltage VDATA2 stored in the parasitic capacitor CPR_PX2 of the second pixel PX2 may continuously decrease. The second transistor T2_PX2 of the second pixel PX2 may be turned on in response to the data write gate signal GW having the turn-on level L_ON to provide the second data voltage VDATA2 stored in the parasitic capacitor CPR_PX2 of the second pixel PX2 to the first node N1_PX2 of the second pixel PX2. The second data voltage VDATA2 stored in the parasitic capacitor CPR_PX2 of the second pixel PX2 may continuously decrease. Accordingly, the gate-source voltage VGS_PX2 of the first transistor T1_PX2 of the second pixel PX2 may be affected by the second data voltage VDATA2 which is stored in the parasitic capacitor CPR_PX2 of the second pixel PX2 and continuously decreases. For example, the gate-source voltage VGS_PX2 of the first transistor T1_PX2 of the second pixel PX2 may decrease due to the influence of the second data voltage VDATA2 which is stored in the parasitic capacitor CPR_PX2 of the second pixel PX2 and continuously decreases.

The gate-source voltage VGS_PX1 of the first transistor T1_PX1 of the first pixel PX1 may be affected by the first data voltage VDATA1 which is stored in the parasitic capacitor CPR_PX1 of the first pixel PX1 and continuously decreases during the third period DU3 and the fourth period DU4.

The gate-source voltage VGS_PX2 of the first transistor T1_PX2 of the second pixel PX2 may be affected by the second data voltage VDATA2 which is stored in the parasitic capacitor CPR_PX2 of the second pixel PX2 and continuously decreases during the fourth period DU4.

A time length during which the gate-source voltage VGS_PX1 of the first transistor T1_PX1 of the first pixel PX1 is affected by a first data voltage VDATA1 which is stored in the parasitic capacitor CPR_PX1 of the first pixel PX1 and continuously decreases may be longer than a time length during which the gate-source voltage VGS_PX2 of the first transistor T1_PX2 of the second pixel PX2 is affected by the second data voltage VDATA2 which is stored in the parasitic capacitor CPR_PX2 of the second pixel PX2 and continuously decreases. Therefore, the influence of the first data voltage VDATA1 which is stored in the parasitic capacitor CPR_PX1 of the first pixel PX1 and continuously decreases may be relatively greater than the influence of the second data voltage VDATA2 which is stored in the parasitic capacitor CPR_PX2 of the second pixel PX2 and continuously decreases.

In summary, when the switching elements SW1, SW2 is turned on in response to the switching signals SWS1, SWS2 having the turn-on level L_ON, and the second transistors T2_PX1, T2_PX2 of the pixels PX1, PX2 is turned on in response to the data write gate signal GW having the turn-on level L_ON, the voltages of the data lines DL1, DL2 may be stably maintained by the data voltage VDATA output from the output channel OC, and the stably maintained voltages of the data lines DL1, DL2 may be provided to the first nodes N1_PX1, N1_PX2 of the pixels PX1, PX2. Accordingly, the gate-source voltages VGS_PX1, VGS_PX2 of the first transistors T1_PX1, T1_PX2 of the pixels PX1, PX2 may be maintained stably.

On the other hand, when the switching elements SW1, SW2 is turned off in response to the switching signal SWS1, SWS2 having the turn-off level L_OFF, and the second transistors T2_PX1, T2_PX2 of the pixels PX1, PX2 is turned on in response to the data write gate signal GW having the turn-on level L_ON, the voltages of the data lines DL1, DL2 may not be stably maintained by the data voltage VDATA output from the output channel OC, the voltages of the data lines DL1, DL2 may continuously decrease, and the voltages of the data lines DL1, DL2 which is continuously decreases may be provided to the first nodes N1_PX1, N1_PX2 of the pixels PX1, PX2. Accordingly, the gate-source voltages VGS_PX1, VGS_PX2 of the first transistors T1_PX1, T1_PX2 of the pixels PX1, PX2 may be affected by the voltages of the data lines DL1, DL2 which is stored in the parasitic capacitors CPR_PX1, CPR_PX2 of the pixels PX1, PX2 and continuously decreases.

The gate-source voltage VGS_PX1 of the first transistor T1_PX1 of the first pixel PX1 may be affected by the first data voltage VDATA1 which is stored in the parasitic capacitor CPR_PX1 of the first pixel PX1 and continuously decreases according to a time length of a first non-overlapping period NOD1. For example, when the time length of the first non-overlapping period NOD1 is long, the gate-source voltage VGS_PX1 of the first transistor T1_PX1 of the first pixel PX1 may be greatly affected by the first data voltage VDATA1 which is stored in the parasitic capacitor CPR_PX1 of the first pixel PX1 and continuously decreases. For example, when the time length of the first non-overlapping period NOD1 is short, the gate-source voltage VGS_PX1 of the first transistor T1_PX1 of the first pixel PX1 may be less affected by the first data voltage VDATA1 which is stored in the parasitic capacitor CPR_PX1 of the first pixel PX1 and continuously decreases.

As the time length of the first non-overlapping period NOD1 is long, a luminance of the first pixel PX1 may decrease, and the gate-source voltage VGS_PX1 of the first transistor T1_PX1 of the first pixel PX1 should be compensated more.

The first non-overlapping period NOD1 may be a non-overlapping period of a turn-on period of the first switching signal SWS1 and the turn-on period of the data write gate signal GW among the turn-on period of the data write gate signal GW.

For example, as shown in FIGS. 5, 10, and 11, the non-overlapping period of the turn-on period of the first switching signal SWS1 and the turn-on period of the data write gate signal GW among the turn-on period of the data write gate signal GW may be a period between a first time point TP1 and a third time point TP3. Therefore, the first non-overlapping period NOD1 may be the period between the first time point TP1 and the third time point TP3. The first non-overlapping period NOD1 may include the third period DU3 and the fourth period DU4.

The gate-source voltage VGS_PX2 of the first transistor T1_PX2 of the second pixel PX2 may be affected by the second data voltage VDATA2 which is stored in the parasitic capacitor CPR_PX2 of the second pixel PX2 and continuously decreases according to a time length of the second non-overlapping period NOD2. For example, when the time length of the second non-overlapping period NOD2 is long, the gate-source voltage VGS_PX2 of the first transistor T1_PX2 of the second pixel PX2 may be greatly affected by the second data voltage VDATA2 which is stored in the parasitic capacitor CPR_PX2 of the second pixel PX2 and continuously decreases. For example, when the time length of the second non-overlapping period NOD2 is short, the gate-source voltage VGS_PX2 of the first transistor T1_PX2 of the second pixel PX2 may be less affected by the second data voltage VDATA2 which is stored in the parasitic capacitor CPR_PX2 of the second pixel PX2 and continuously decreases.

As the time length of the second non-overlapping period NOD2 is long, a luminance of the second pixel PX2 may decrease, and the gate-source voltage VGS_PX2 of the first transistor T1_PX2 of the second pixel PX2 should be compensated more.

The second non-overlapping period NOD2 may be a non-overlapping period of a turn-on period of the second switching signal SWS2 and the turn-on period of the data write gate signal GW among the turn-on period of the data write gate signal GW.

For example, as shown in FIGS. 5, 10, and 11, the non-overlapping period of the turn-on period of the second switching signal SWS2 and the turn-on period of the data write gate signal GW among the turn-on period of the data write gate signal GW may be a period between a second time point TP2 and the third time point TP3. Therefore, the second non-overlapping period NOD2 may be the period between the second time point TP2 and the third time point TP3. The second non-overlapping period NOD2 may include the fourth period DU4.

As shown in FIGS. 10 and FIG. 11, the time length of the first non-overlapping period NOD1 may be longer than the time length of the second non-overlapping period NOD2. In this case, when the first data voltage VDATA1 and the second data voltage VDATA2 are the same, the luminance of the first pixel PX1 may be less than the luminance of the second pixel PX2. Therefore, the gate-source voltage VGS_PX1 of the first transistor T1_PX1 of the first pixel PX1 should be compensated more than the gate-source voltage VGS_PX2 of the first transistor T1_PX2 of the second pixel PX2. For this purpose, the first data voltage VDATA1 should increase.

As such, when a display device includes the demultiplexer 600, a problem may occur in which a luminance of some of the pixels PX1, PX2 decrease.

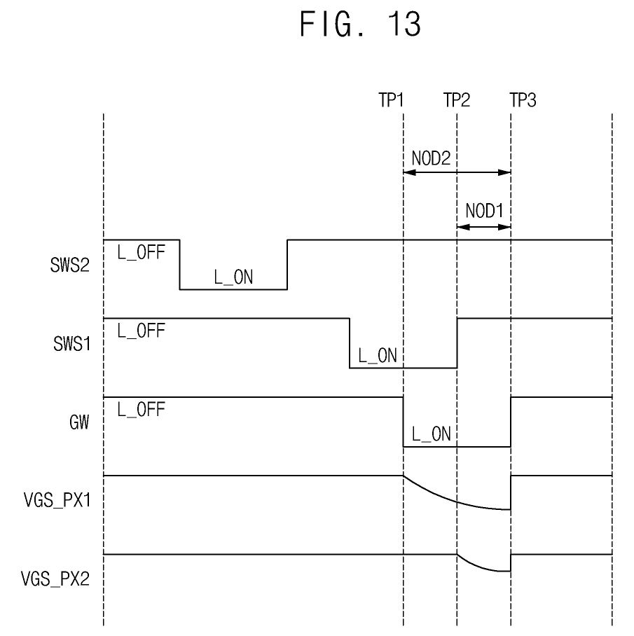

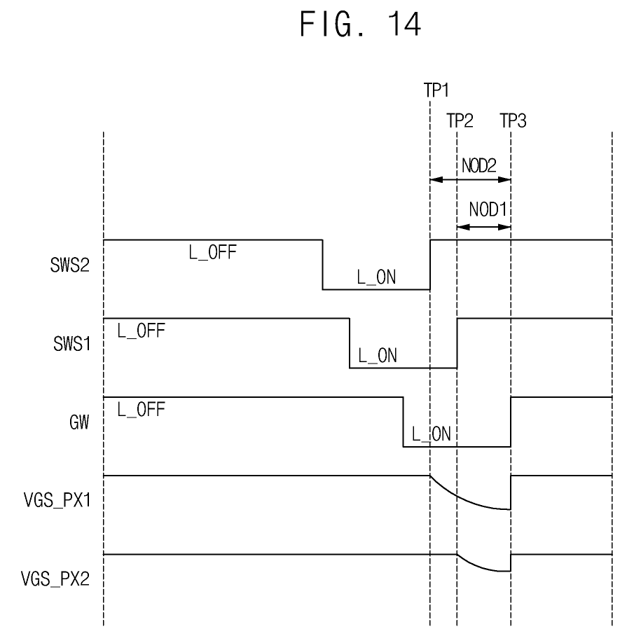

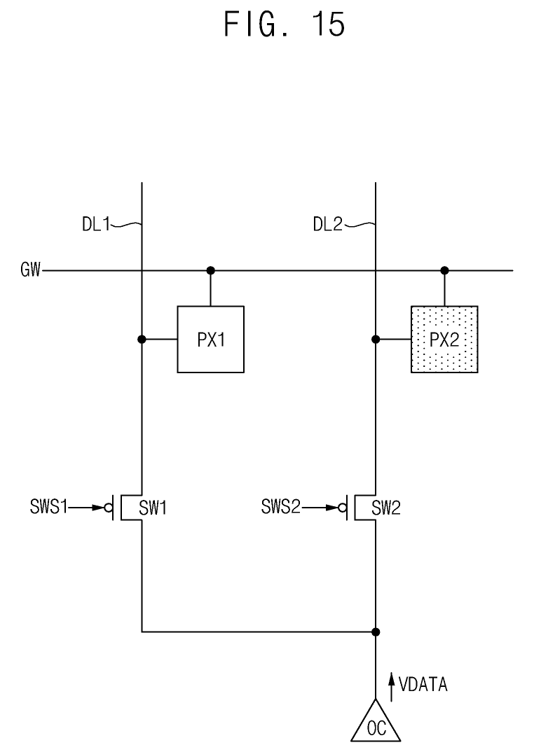

FIGS. 13 and FIG.14 are timing diagrams showing non-overlapping periods NOD1, NOD2 according to a data write gate signal GW and switching signals SWS1, SWS2 of FIG. 5. FIG. 15 is a circuit diagram showing a luminance of pixels PX1, PX2 of FIG. 3 according to a driving method of FIGS. 13 and FIG. 14.

The first non-overlapping period NOD1 may be the non-overlapping period of the turn-on period of the first switching signal SWS1 and the turn-on period of the data write gate signal GW among the turn-on period of the data write gate signal GW.

As the time length of the first non-overlapping period NOD1 is long, the luminance of the first pixel PX1 may decrease, and the gate-source voltage VGS_PX1 of the first transistor T1_PX1 of the first pixel PX1 should be compensated more.

The second non-overlapping period NOD2 may be the non-overlapping period of the turn-on period of the second switching signal SWS2 and the turn-on period of the data write gate signal GW among the turn-on period of the data write gate signal GW.

As the time length of the second non-overlapping period NOD2 is long, the luminance of the second pixel PX2 may decrease, and the gate-source voltage VGS_PX2 of the first transistor T1_PX2 of the second pixel PX2 should be compensated more.

For example, as shown in FIGS. 13 and FIG. 14, the non-overlapping period of the turn-on period of the first switching signal SWS1 and the turn-on period of the data write gate signal GW among the turn-on period of the data write gate signal GW may be a period between a second time point TP2 and a third time point TP3. Therefore, the first non-overlapping period NOD1 may be the period between the second time point TP2 and the third time point TP3.

For example, as shown in FIGS. 13 and FIG. 14, the non-overlapping period of the turn-on period of the second switching signal SWS2 and the turn-on period of the data write gate signal GW among the turn-on period of the data write gate signal GW may be a period between a first time point TP1 and the third time point TP3. Therefore, the second non-overlapping period NOD2 may be the period between the first time point TP1 and the third time point TP3.

The time length of the second non-overlapping period NOD2 may be longer than the time length of the first non-overlapping period NOD1. In this case, when the first data voltage VDATA1 and the second data voltage VDATA2 are the same, the luminance of the second pixel PX2 may be less than the luminance of the first pixel PX1. Therefore, the gate-source voltage of the first transistor T1_PX2 of the second pixel PX2 should be compensated more than the gate-source voltage of the first transistor T1_PX1 of the first pixel PX1. For this purpose, the second data voltage VDATA2 should be increased.

As such, when a display device includes the demultiplexer 600, a problem may occur in which the luminance of the some pixel PX2 among the pixels PX1, PX2 decrease.

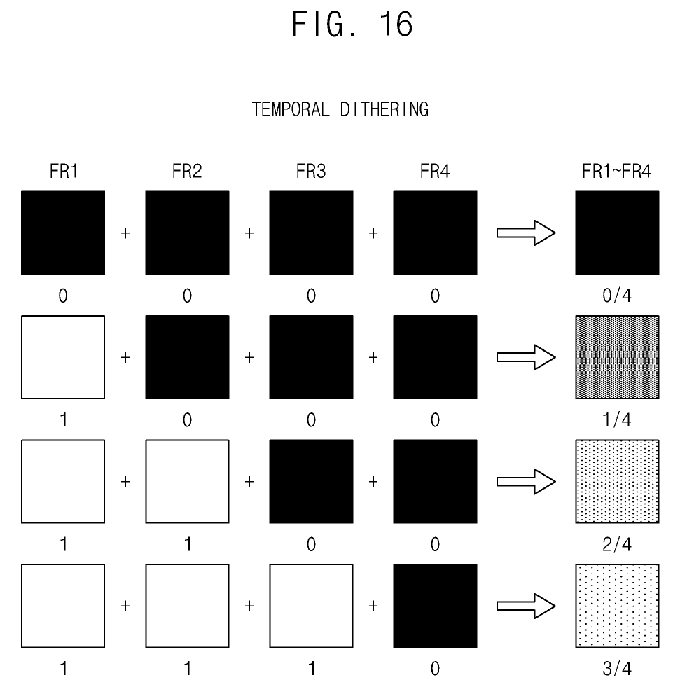

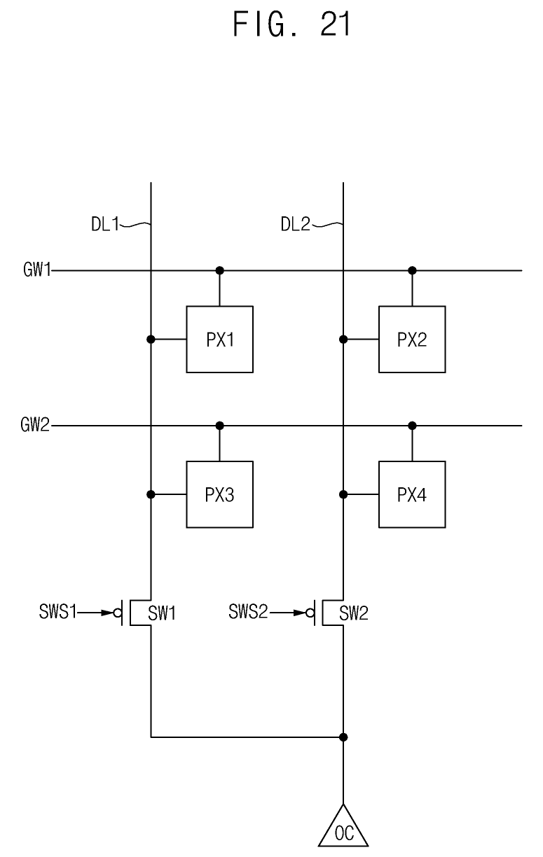

FIGS. 2-15 describe the problem which occurs when the display device includes the demultiplexer 600. FIGS. 16-20 describe a dithering, and FIGS. 21-29 describe a display quality problem which occurs in the dithering and the present inventive concept which solves the display quality problem when the display device includes the demultiplexer 600.

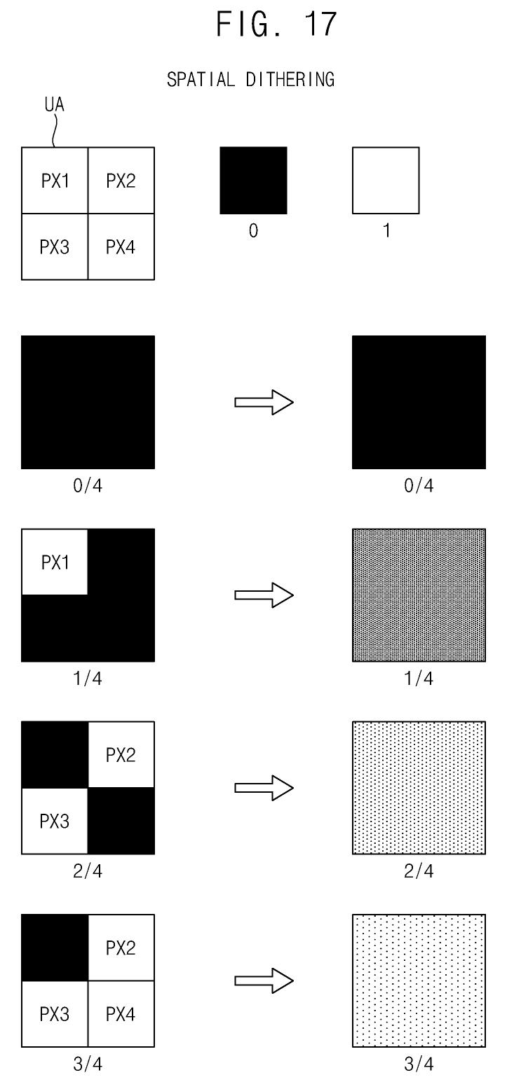

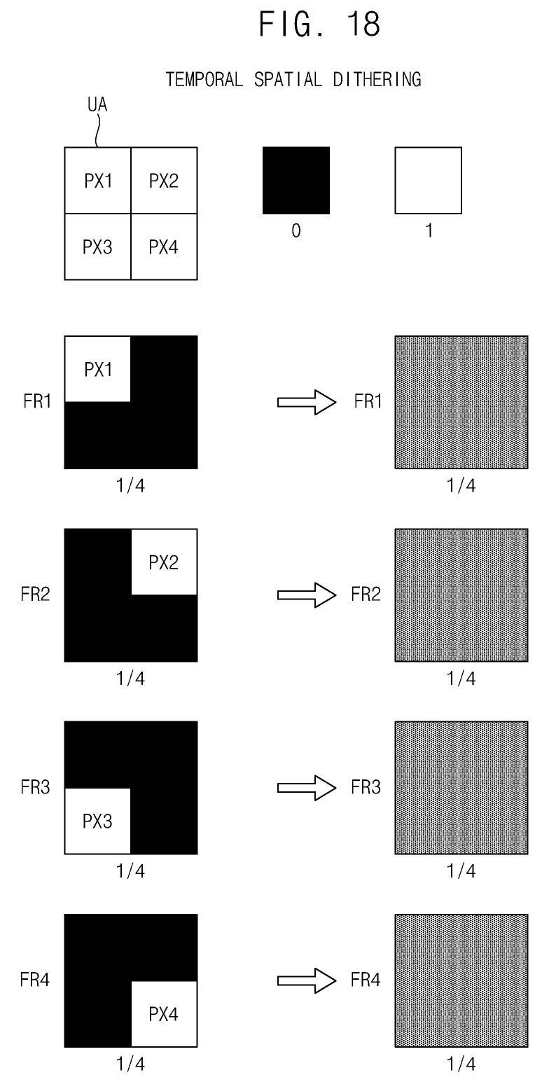

FIG. 16 is a conceptual diagram showing a temporal dithering. FIG. 17 is a conceptual diagram showing a spatial dithering. FIG. 18 is a conceptual diagram showing a temporal spatial dithering.

Referring to FIGS. 1-18, a grayscale of input image data IMG may have N bits (Here, N is a positive integer), and the data voltage VDATA output from the data driver 500 may have M bits (Here, M is a positive integer less than N). For example, the grayscale of the input image data IMG may have 8 bit, and the data voltage VDATA output from the data driver 500 may have 6 bit. That is, the grayscale of the input image data IMG may have grayscales from 0 to 255 in units of 1 grayscale. On the other hand, the data voltage VDATA output from the data driver 500 may have grayscales from 0 to 255 in units of 4 grayscale.

A display device may perform a dithering operation to express N bits of the grayscale of the input image data IMG, which is greater than M bits of the data voltage VDATA output from the data driver 500. Specifically, the display device may express a target grayscale between a first reference grayscale “0” and a second reference grayscale “1” based on the first reference grayscale “0” and the second reference grayscale “1.” Here, each of the first reference grayscale “0” and the second reference grayscale “1” may be a grayscale which is expressed by the data voltage VDATA output from the data driver 500. For example, the first reference grayscale “0” may be 0 grayscale, and the second reference grayscale “1” may be 4 grayscale.

A method of performing the dithering operation may include a temporal dithering, a spatial dithering, or a temporal spatial dithering.

The temporal dithering may display the first reference grayscale “0” and the second reference grayscale “1” during a plurality of frames to express the input grayscale between the first reference grayscale “0” and the second reference grayscale “1” by a temporal combination.

For example, when the first reference grayscale “0” is displayed during all frames FR1 to FR4 among the first to fourth frames FR1 to FR4, the input grayscale “0/4” may be expressed. That is, the input grayscale “0/4” may be perceived by the user during the frames FR1 to FR4. For example, the input grayscale “0/4” may be 0 grayscale.

For example, when the second reference grayscale “1” is displayed during one frame FR1 among the first to fourth frames FR1 to FR4, the input grayscale “1/4” may be expressed. That is, the input grayscale “1/4” may be perceived by the user during the frames FR1 to FR4. For example, the input grayscale “1/4” may be 1 grayscale.

For example, when the second reference grayscale “1” is displayed during two frames FR1, FR2 among the first to fourth frames FR1 to FR4, the input grayscale “2/4” may be expressed. That is, the input grayscale “2/4” may be perceived by the user during the frames FR1 to FR4. For example, the input grayscale “2/4” may be 2 grayscale.

For example, when the second reference grayscale “1” is displayed during three frames FR1, FR2, FR3 among the first to fourth frames FR1 to FR4, the input grayscale “3/4” may be expressed. That is, the input grayscale “3/4” may be perceived by the user during the frames FR1 to FR4. For example, the input grayscale “3/4” may be 3 grayscale.

The spatial dithering may display the first reference grayscale “0” and the second reference grayscale “1” on adjacent pixels PX to express the input grayscale between the first reference grayscale “0” and the second reference grayscale “1” by a spatial combination. Here, a map generated by combining the first reference grayscale “0” and the second reference grayscale “1” may be referred to as a dithering map.

In an embodiment, the spatial dithering may be performed in units of a unit area UA. That is, the dithering map may be generated in units of the unit area UA. Here, the unit area UA may be units of the adjacent pixels PX which express the input grayscale. For example, the unit area UA may include 2×2 pixels PX1 to PX4. For example, the dithering map may have the first reference grayscale “0” or the second reference grayscale “1” for each of the 2×2 pixels PX1 to PX4.

For example, when the first reference grayscale “0” is displayed in all pixels PX1 to PX4 among the 2×2 pixels PX1 to PX4, the input grayscale “0/4” may be expressed. That is, the input grayscale “0/4” may be perceived by the user in the unit area UA. For example, the input grayscale “0/4” may be a 0 grayscale.

For example, when the second reference grayscale “1” is displayed in one pixel PX1 among the 2×2 pixels PX1 to PX4, the input grayscale “1/4” may be expressed. That is, the input grayscale “1/4” may be perceived by the user in the unit area UA. For example, the input grayscale “1/4” may be 1 grayscale.

For example, when the second reference grayscale “1” is displayed in two pixels PX2, PX3 of the 2×2 pixels PX1 to PX4, the input grayscale “2/4” may be expressed. That is, the input grayscale “2/4” may be perceived by the user in the unit area UA. For example, the input grayscale “2/4” may be 2 grayscale.

For example, when the second reference grayscale “1” is displayed in three pixels PX2, PX3, PX4 of the 2×2 pixels PX1 to PX4, the input grayscale “3/4” may be expressed. That is, the input grayscale “3/4” may be perceived by the user in the unit area UA. For example, the input grayscale “3/4” may be 3 grayscale.

The temporal spatial dithering may use the temporal dithering and the spatial dithering. Specifically, the temporal spatial dithering may represent the input grayscale between the first reference grayscale “0” and the second reference grayscale “1” based on the dithering map. The dithering map for representing the input grayscale may be changed during the frames. The temporal spatial dithering may be performed when the input grayscale is less than a threshold grayscale. For example, the threshold grayscale may be 16 grayscale. That is, the temporal spatial dithering may be performed at a low grayscale.

For example, when a dithering map is used in which the second reference grayscale “1” is displayed in one pixel PX1 during the first frame FR1 among the first to fourth frames FR1 to FR4, the input grayscale “1/4” may be expressed. That is, the input grayscale “1/4” may be perceived by the user in the unit area UA. For example, the input grayscale “1/4” may be grayscale 1.

For example, when a dithering map is used in which the second reference grayscale “1” is displayed in one pixel PX2 during the second frame FR2 among the first to fourth frames FR1 to FR4, the input grayscale “1/4” may be expressed. That is, the input grayscale “1/4” may be perceived by the user in the unit area UA. For example, the input grayscale “1/4” may be grayscale 1.

For example, when a dithering map is used in which the second reference grayscale “1” is displayed in one pixel PX2 during the third frame FR3 among the first to fourth frames FR1 to FR4, the input grayscale “1/4” may be expressed. That is, the input grayscale “1/4” may be perceived by the user in the unit area UA. For example, the input grayscale “1/4” may be 1 grayscale.

For example, when a dithering map is used in which the second reference grayscale “1” is displayed in one pixel PX2 during the fourth frame FR4 among the first to fourth frames FR1 to FR4, the input grayscale “1/4” may be expressed. That is, the input grayscale “1/4” may be perceived by the user in the unit area UA. For example, the input grayscale “1/4” may be grayscale 1.

As such, the temporal spatial dithering may chang the dithering map during the frames to express the input grayscale between the first reference grayscale “0” and the second reference grayscale “1”.

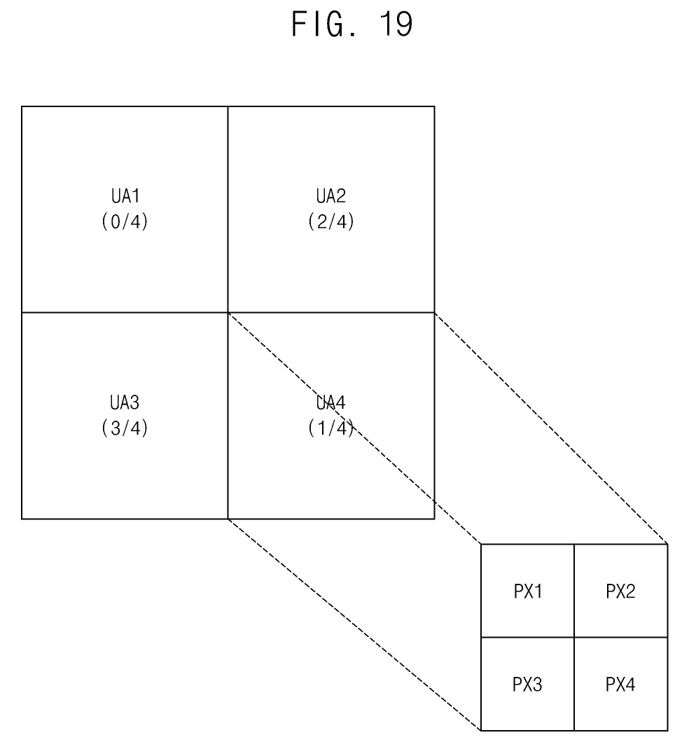

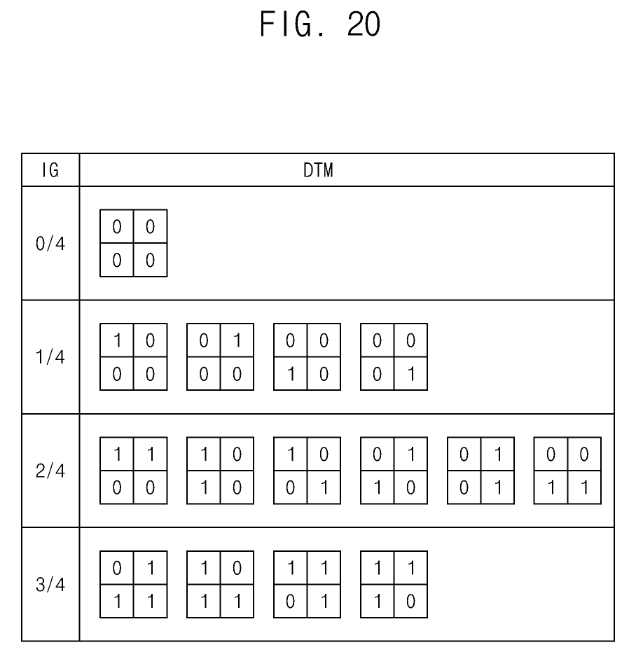

FIG. 19 is a diagram showing an input grayscale of each of unit areas UA1 to UA4 and pixels PX1 to PX4 included in each of the unit areas UA1 to UA4. FIG. 20 is a diagram showing a dithering map DTM used for a temporal spatial dithering.

Referring to FIGS. 1-20, a driving controller 200 may divide pixels PX included in a display panel 100 into the unit area UA based on the input image data IMG.

For example, the input image data IMG may have a 2×2 resolution, and the pixels PX included in the display panel 100 may have a 4×4 resolution. The driving controller 200 may divide the pixels PX having the 4×4 resolution into 2×2 unit areas UA1 to UA4. Therefore, each of the 2×2 unit areas UA1 to UA4 may include 2×2 pixels PX1 to PX4.

Each of the 2×2 unit areas UA1 to UA4 may have the input grayscale IG. The 2×2 pixels PX1 to PX4 included in each of the 2×2 unit areas UA1 to UA4 may display the first reference grayscale “0” and the second reference grayscale “1” adjacent to the input grayscale IG, such that the input grayscale IG may be perceived by the user in each of the 2×2 unit areas UA1 to UA4.

For example, the first reference grayscale “0” may be 0 grayscale, and the second reference grayscale “1” may be 4 grayscale. In this case, the input grayscale IG may be a value between 0 grayscale and 4 grayscale. For example, an input grayscale IG “0/4” of a first unit area UA1 may be 0 grayscale, an input grayscale IG “2/4” of a second unit area UA2 may be 2 grayscale, an input grayscale IG “3/4” of a third unit area UA3 may be 3 grayscale, and an input grayscale IG “1/4” of a fourth unit area UA4 may be 1 grayscale.

The temporal spatial dithering may use the dithering map DTM, and the input grayscale IG may be expressed for the unit area UA based on the dithering map DTM.

For example, the first reference grayscale “0” may be 0 grayscale, and the second reference grayscale “1” may be 4 grayscale. In this case, the input grayscale IG may be a value between 0 grayscale and 4 grayscale. When the input grayscale IG is 0 grayscale (i.e., “0/4”), the first reference grayscale “0” may be displayed in all pixels among the pixels PX1 to PX4 included in each of the dithering maps DTM. Accordingly, the input grayscale IG of 0 grayscale may be perceived by the user in the unit area UA.

For example, the first reference grayscale “0” may be 0 grayscale, and the second reference grayscale “1” may be 4 grayscale. When the input grayscale IG is 1 grayscale (i.e., “1/4”), the second reference grayscale “1” may be displayed in one pixel among the pixels PX1 to PX4 included in each of the dithering maps DTM. Accordingly, the input grayscale IG of 1 grayscale may be perceived by the user in the unit area UA.

For example, the first reference grayscale “0” may be grayscale 0, and the second reference grayscale “1” may be grayscale 4. When the input grayscale IG is 2 grayscale (i.e., “2/4”), the second reference grayscale “1” may be displayed in two pixels among the pixels PX1 to PX4 included in each of the dithering maps DTM. Accordingly, the input grayscale IG of 2 grayscale may be perceived by the user in the unit area UA.

For example, the first reference grayscale “0” may be grayscale 0, and the second reference grayscale “1” may be grayscale 4. When the input grayscale IG is 3 grayscale (i.e., “3/4”), the second reference grayscale “1” may be displayed in three pixels among the pixels PX1 to PX4 included in each of the dithering maps DTM. Accordingly, the input grayscale IG of 3 grayscale may be perceived by the user in the unit area UA.

FIG. 21 is a circuit diagram showing pixels PX1 to PX4 included in a unit area UA, a demultiplexer 600 connected to the pixels PX1 to PX4, and an output channel OC connected to the demultiplexer 600.

Referring to FIGS. 1-21, the unit area UA may include the 2×2 pixels PX1 to PX4. For example, the unit area UA may include first to fourth pixels PX1 to PX4. FIG. 21 shows that the unit area UA includes four pixels PX1 to PX4, but the present inventive concept is not limited thereto.

The first pixel PX1 and the third pixel PX3 may be connected to a first data line DL1. The second pixel PX2 and the fourth pixel PX4 may be connected to a second data line DL2. The first pixel PX1 and the second pixel PX2 may receive a first data write gate signal GW1. The third pixel PX3 and the fourth pixel PX4 may receive a second data write gate signal GW2.

A demultiplexer 600 may selectively connect an output channel OC to each of the first data line DL1 and the second data line DL2. For example, the demultiplexer 600 may be a 2:1 demultiplexer and may include a first switching element SW1 and a second switching element SW2.

In an embodiment, the first switching element SW1 and the second switching element SW2 may be the P-type transistors. For example, the P-type transistor may be the PMOS transistor.

The first switching element SW1 may be turned on in response to a first switching signal SWS1 having the turn-on level L_ON to connect the output channel OC and the first data line DL1. The second switching element SW2 may be turned on in response to a second switching signal SWS2 having the turn-on level L_ON to connect the output channel OC and the second data line DL2.

The output channel OC may be connected to the first switching element SW1 and the second switching element SW2 and may output a data voltage VDATA.

When the output channel OC outputs the data voltage VDATA and the first switching element SW1 is turned on in response to the first switching signal SWS1 having the turn-on level L_ON, the data voltage VDATA output from the output channel OC may be provided to the first data line DL1. When the first data write gate signal GW1 has the turn-on level L_ON, the data voltage VDATA provided to the first data line DL1 may be provided to the first pixel PX1. When the second data write gate signal GW2 has the turn-on level L_ON, the data voltage VDATA provided to the first data line DL1 may be provided to the third pixel PX3.

When the output channel OC outputs the data voltage VDATA and the second switching element SW2 is turned on in response to the second switching signal SWS2 having the turn-on level L_ON, the data voltage VDATA output from the output channel OC may be provided to the second data line DL2. When the first data write gate signal GW1 has the turn-on level L_ON, the data voltage VDATA provided to the second data line DL2 may be provided to the second pixel PX2. When the second data write gate signal GW2 has the turn-on level L_ON, the data voltage VDATA provided to the second data line DL2 may be provided to the fourth pixel PX4.

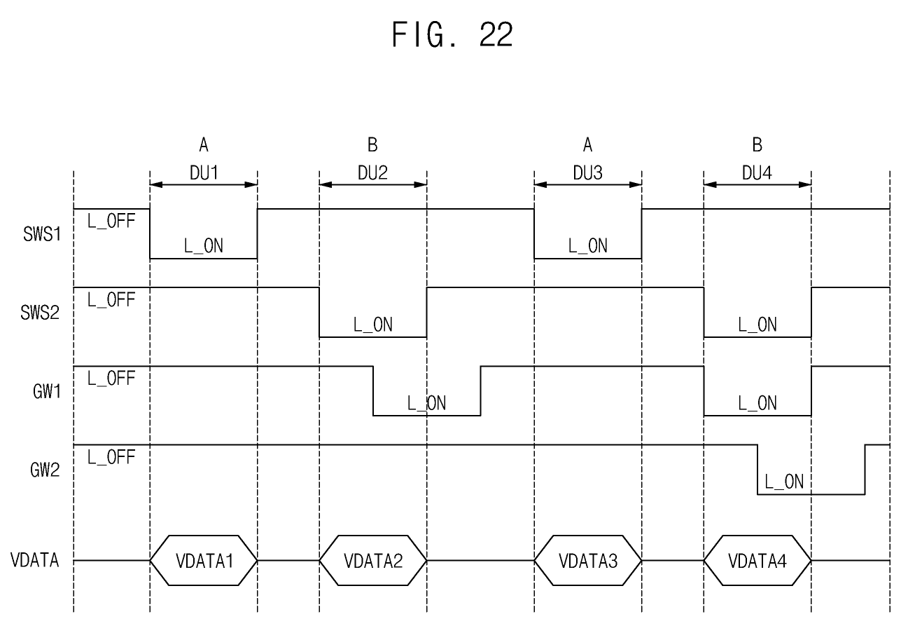

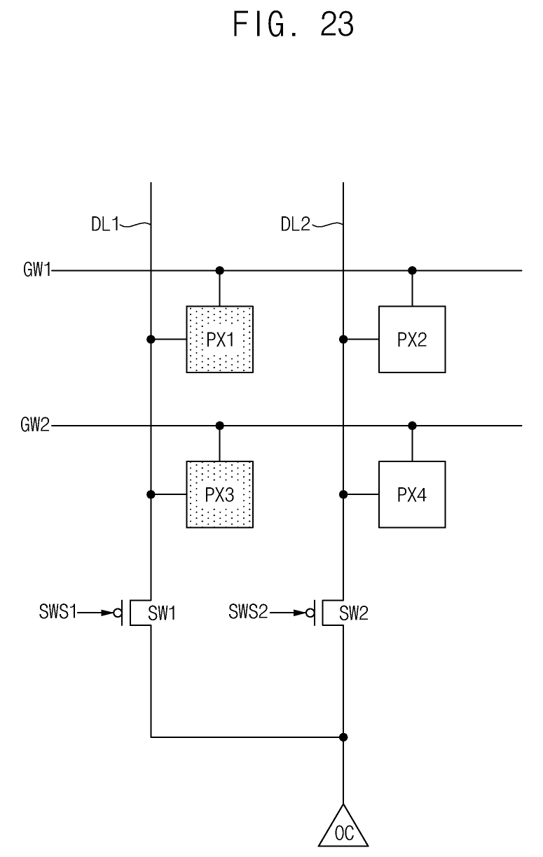

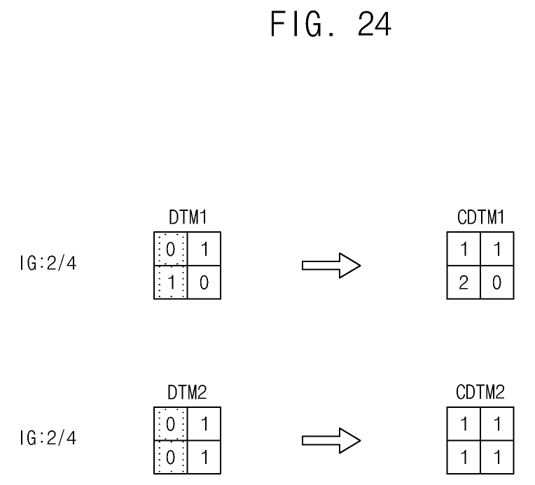

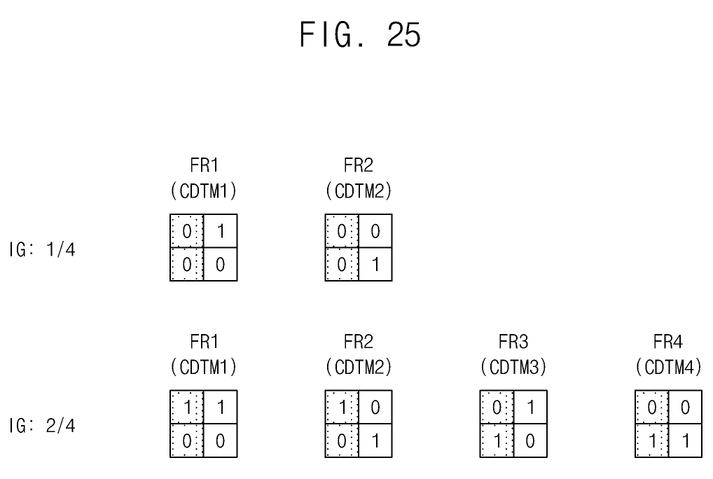

FIG. 22 is a timing diagram showing a first driving method of a demultiplexer 600. FIG. 23 is a circuit diagram showing a luminance of pixels PX1 to PX4 of FIG. 21 in a driving method of FIG. 22. FIG. 24 is a diagram showing an example of a compensation dithering map which compensates for a luminance of pixels PX1 to PX4 of FIG. 21 in a driving method of FIG. 22. FIG. 25 is a diagram showing another example of a compensation dithering map which compensates for a luminance of pixels PX1 to PX4 of FIG. 21 in a driving method of FIG. 22.

Referring to FIGS. 1-25, sequentially, the first switching signal SWS1 may have the turn-on level L_ON, the second switching signal SWS2 may have the turn-on level L_ON, the first switching signal SWS1 may have the turn-on level L_ON, and the second switching signal SWS2 may have the turn-on level L_ON. As such, when the first switching signal SWS1 “A” having the turn-on level L_ON and the second switching signal SWS2 “B” having the turn-on level L_ON are repeated in an order of “ABAB,” the demultiplexer 600 may operate in a first driving mode.

In a first period DU1, the output channel OC may output a first data voltage VDATA1. The first switching element SW1 may be turned on in response to the first switching signal SWS1 having the turn-on level L_ON to connect the output channel OC and the first data line DL1. Therefore, the first data voltage VDATA1 may be provided to the first data line DL1. When the first data write gate signal GW1 has the turn-on level L_ON, the first data voltage VDATA1 provided to the first data line DL1 may be provided to the first pixel PX1.

In a second period DU2, the output channel OC may output a second data voltage VDATA2. The second switching element SW2 may be turned on in response to the second switching signal SWS2 having the turn-on level L_ON to connect the output channel OC and the second data line DL2. Therefore, the second data voltage VDATA2 may be provided to the second data line DL2. When the first data write gate signal GW1 has the turn-on level L_ON, the second data voltage VDATA2 provided to the second data line DL2 may be provided to the second pixel PX2.

In a third period DU3, the output channel OC may output a third data voltage VDATA3. The first switching element SW1 may be turned on in response to the first switching signal SWS1 having the turn-on level L_ON to connect the output channel OC and the first data line DL1. Therefore, the third data voltage VDATA3 may be provided to the first data line DL1. When the second data write gate signal GW2 has the turn-on level L_ON, the third data voltage VDATA3 provided to the first data line DL1 may be provided to the third pixel PX3.

In a fourth period DU4, the output channel OC may output a fourth data voltage VDATA4. The second switching element SW2 may be turned on in response to the second switching signal SWS2 having the turn-on level L_ON to connect the output channel OC and the second data line DL2. Therefore, the fourth data voltage VDATA4 may be provided to the second data line DL2. When the second data write gate signal GW2 has the turn-on level L_ON, the fourth data voltage VDATA4 provided to the second data line DL2 may be provided to the fourth pixel PX4.

A non-overlapping period of a turn-on period of the first switching signal SWS1 and a turn-on period of the first data write gate signal GW1 among the turn-on period of the first data write gate signal GW1 may be longer than a non-overlapping period of a turn-on period of the second switching signal SWS2 and a turn-on period of the first data write gate signal GW1 among the turn-on period of the first data write gate signal GW1. That is, a time length of a non-overlapping period of the first pixel PX1 may be longer than a time length of the non-overlapping period of the second pixel PX2. Therefore, a luminance of the first pixel PX1 may be less than a luminance of the second pixel PX2.

A non-overlapping period of a turn-on period of the first switching signal SWS1 and a turn-on period of the second data write gate signal GW2 among the turn-on period of the second data write gate signal GW2 may be longer than a non-overlapping period of a turn-on period of the second switching signal SWS2 and the turn-on period of the second data write gate signal GW2 among the turn-on period of the second data write gate signal GW2. That is, a time length of a non-overlapping period of the third pixel PX3 may be longer than a time length of a non-overlapping period of the fourth pixel PX4. Therefore, a luminance of the third pixel PX3 may be less a the luminance of the fourth pixel PX4.

As such, when the display device includes the demultiplexer 600, a problem may occur in which the luminance of the some pixels PX1, PX3 among the pixels PX1, PX2, PX3, PX4 decreases. Therefore, when the display device includes the demultiplexer 600 and performs the temporal spatial dithering, the luminance of the unit area UA may not be constant, and a display quality may not be constant. Specifically, when the demultiplexer 600 operates in the first driving method, the luminance of the first pixel PX1 and the luminance of the third pixel PX3 may be small and should be compensated.

The driving controller 200 may compensate for the dithering map DTM to compensate for the luminance of the first pixel PX1 and the luminance of the third pixel PX3.

In an embodiment, the driving controller 200 may increase a reference grayscale of the some pixels PX1, PX3 whose luminance decreases and which are included in the dithering map DTM. Specifically, the driving controller 200 may increase a reference grayscale of the first pixel PX1 and a reference grayscale of the third pixel PX3, which are included in the dithering map DTM. Accordingly, the first data voltage VDATA1 provided to the first pixel PX1 may increase, and the third data voltage VDATA3 provided to the third pixel PX3 may increase.

As shown in FIG. 24, for example, an input grayscale IG of a first dithering map DTM1 may be “2/4”. The first dithering map DTM1 may have the first reference grayscale “0” in the first pixel PX1, the second reference grayscale “1” in the second pixel PX2, the second reference grayscale “1” in the third pixel PX3, and the first reference grayscale “0” in the fourth pixel PX4. Here, the first dithering map DTM1 may be a dithering map before compensation. Therefore, the luminance of the first pixel PX1 and the luminance of the third pixel PX3 according to the first dithering map DTM1 may be small and should be compensated. Therefore, the driving controller 200 may compensate for the first dithering map DTM1 to generate a first compensation dithering map CDTM1. Here, the first compensation dithering map CDTM1 may be a dithering map after compensation. Specifically, the driving controller 200 may increase the first reference grayscale “0” to the second reference grayscale “1” in the first pixel PX1. The driving controller 200 may increase the second reference grayscale “1” to the third reference grayscale “2” in the third pixel PX3. Accordingly, the luminance of the first pixel PX1 and the luminance of the third pixel PX3 may be compensated, and even if the display device includes the demultiplexer 600 and performs the temporal spatial dithering, the luminance of the unit area UA may be constant, and the display quality may be constant.

As shown in FIG. 24, for example, an input grayscale IG of a second dithering map DTM2 may be “2/4”. The second dithering map DTM2 may have the first reference grayscale “0” in the first pixel PX1, the second reference grayscale “1” in the second pixel PX2, the first reference grayscale “0” in the third pixel PX3, and the second reference grayscale “1” in the fourth pixel PX4. Here, the second dithering map DTM2 may be the dithering map before compensation. Therefore, the luminance of the first pixel PX1 and the luminance of the third pixel PX3 according to the second dithering map DTM2 may be small and should be compensated. Therefore, the driving controller 200 may compensate for the second dithering map DTM2 to generate the second compensation dithering map CDTM2. Here, the second compensation dithering map CDTM2 may be a dithering map after compensation. Specifically, the driving controller 200 may increase the first reference grayscale “0” to the second reference grayscale “1” in the first pixel PX1. The driving controller 200 may increase the first reference grayscale “0” to the second reference grayscale “1” in the third pixel PX3. Accordingly, the luminance of the first pixel PX1 and the luminance of the third pixel PX3 may be compensated, and even if the display device includes the demultiplexer 600 and performs the temporal spatial dithering, the luminance of the unit area UA may be constant, and the display quality may be constant.

As such, the driving controller 200 may compensate for the dithering map DTM according to a non-overlapping period of a turn-on period of switching signals SWS1, SWS2 and a turn-on period of data write gate signals GW1, GW2 among the turn-on period of the data write gate signals GW1, GW2 for each of the first to fourth pixels PX1 to PX4. Accordingly, the luminance of the some pixels PX1, PX3 among the pixels PX1, PX2, PX3, PX4 may be compensated, and even if the display device includes the demultiplexer 600 and performs the temporal spatial dithering, the luminance of the unit area UA may be constant, and the display quality may be constant.

In an embodiment, the driving controller 200 may select a compensation dithering map CDTM such that a ratio of a number of pixel PX having the second reference grayscale “1” in the some pixels PX1, PX3 having the reduced luminance becomes a target ratio. When the some pixels PX1, PX3 having the reduced luminance have the first reference grayscale “0” or the second reference grayscale “1”, a degree of a luminance reduction in each case may be different. When the ratio of the number of pixel PX having the second reference grayscale “1” in the some pixels PX1, PX3 having the reduced luminance becomes constant as the target ratio, the degree of the luminance reduction of the unit area UA may be constant, and the display quality may be constant.

As shown in FIG. 25, for example, an input grayscale IG of each of the first and second compensation dithering maps CDTM1, CDTM2 may be “1/4”. Here, the luminance of the first pixel PX1 and the luminance of the third pixel PX3 according to each of the first and second compensation dithering maps CDTM1, CDTM2 may be small. Therefore, the driving controller 200 may select the compensation dithering map CDTM such that the ratio of the number of pixels PX having the second reference grayscale “1” in the first and third pixels PX1, PX3 whose luminance decreases may become the target ratio. For example, the target ratio may be “0/2”.

During a first frame FR1, the first compensation dithering map CDTM1 may have the first reference grayscale “0” in the first pixel PX1 and the third pixel PX3, and the ratio of the number of pixel PX having the second reference grayscale “1” in the first and third pixels PX1, PX3 whose luminance decreases may be “0/2”. During a second frame FR2, the second compensation dithering map CDTM2 may have the first reference grayscale “0” in the first pixel PX1 and the third pixel PX3, and the ratio of the number of pixel PX having the second reference grayscale “1” in the first and third pixels PX1, PX3 whose luminance decreases may be “0/2”. Accordingly, each of the first and second compensation dithering maps CDTM1, DTM2 may have the constant degree of the compensation reduction in the unit area UA, and the display quality may be constant.

As shown in FIG. 25, for example, an input grayscale IG of each of first, second, third, and fourth compensation dithering maps CDTM1, CDTM2, CDTM3, CDTM4 may be “2/4”. Here, the luminance of the first pixel PX1 and the luminance of the third pixel PX3 according to each of the first, second, third, and fourth compensation dithering maps CDTM1, CDTM2, CDTM3, CDTM4 may be small. Therefore, the driving controller 200 may select the compensation dithering map CDTM such that the ratio of the number of pixel PX having the second reference grayscale “1” in the first and third pixels PX1, PX3 whose luminance decreases may become the target ratio. For example, the target ratio may be “1/2”.

During a first frame FR1, the first compensation dithering map CDTM1 may have the second reference grayscale “1” in the first pixel PX1 and the first reference grayscale “0” in the third pixel PX3, and the ratio of the number of pixel PX having the second reference grayscale “1” in the first and third pixels PX1, PX3 whose luminance decreases may be “1/2”. During a second frame FR2, the second compensation dithering map CDTM2 may have the second reference grayscale “1” in the first pixel PX1 and the first reference grayscale “0” in the third pixel PX3, and the ratio of the number of pixel PX having the second reference grayscale “1” in the first and third pixels PX1, PX3 whose luminance decreases may be “1/2”. During a third frame FR3, the third compensation dithering map CDTM3 may have the first reference grayscale “0” in the first pixel PX1 and the second reference grayscale “1” in the third pixel PX3, and the ratio of the number of pixel PX having the second reference grayscale “1” in the first and third pixels PX1, PX3 whose luminance decreases may be “1/2”. During a fourth frame FR4, the fourth compensation dithering map CDTM4 may have the first reference grayscale “0” in the first pixel PX1 and the second reference grayscale “1” in the third pixel PX3, and the ratio of the number of pixel PX having the second reference grayscale “1” in the first and third pixels PX1, PX3 whose luminance decreases may be “1/2”. Accordingly, each of the first, second, third, and fourth compensation dithering maps CDTM1, CDTM2, CDTM3, CDTM4 may have the constant degree of the compensation reduction of the unit area UA, and the display quality may be constant.

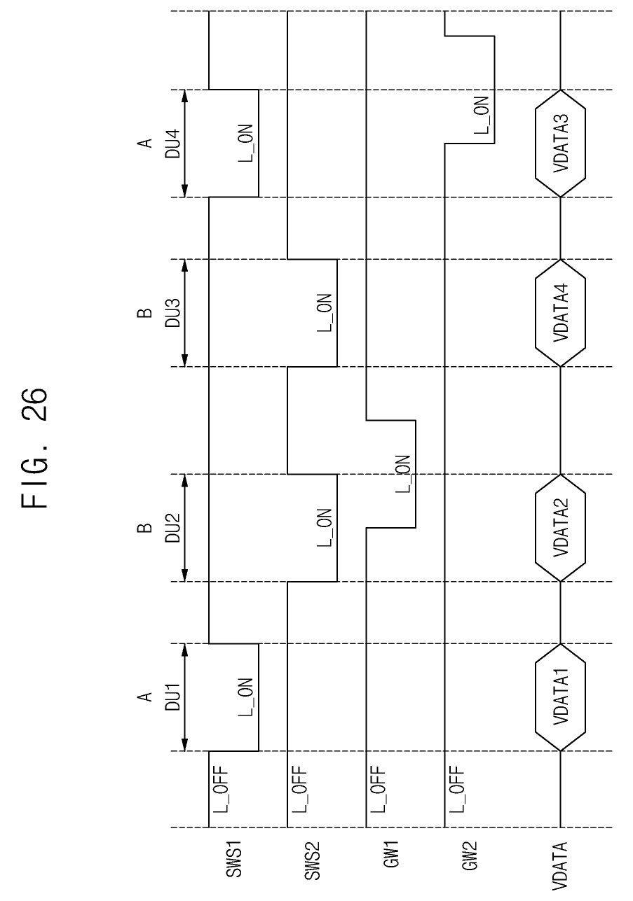

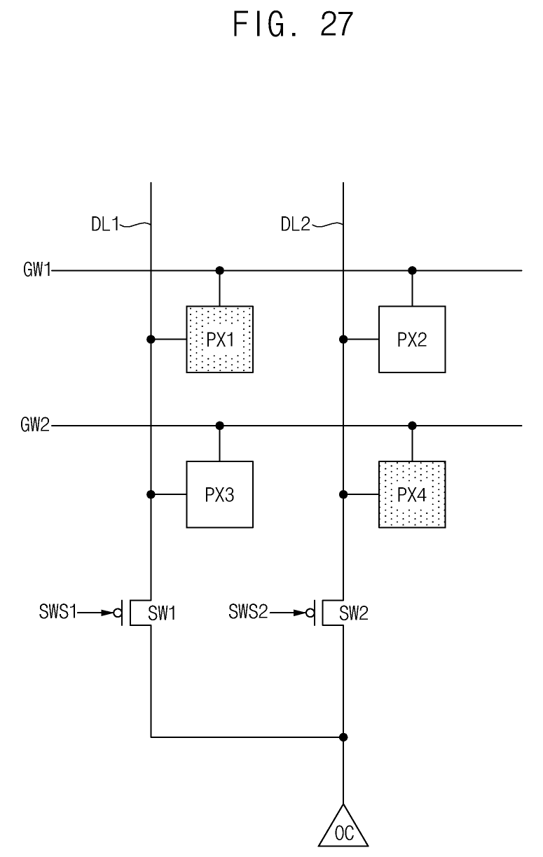

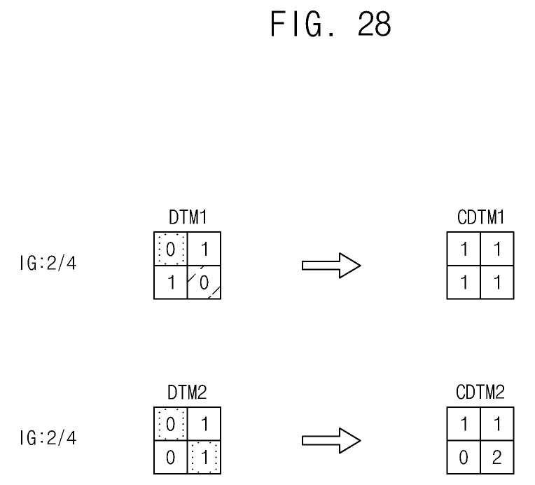

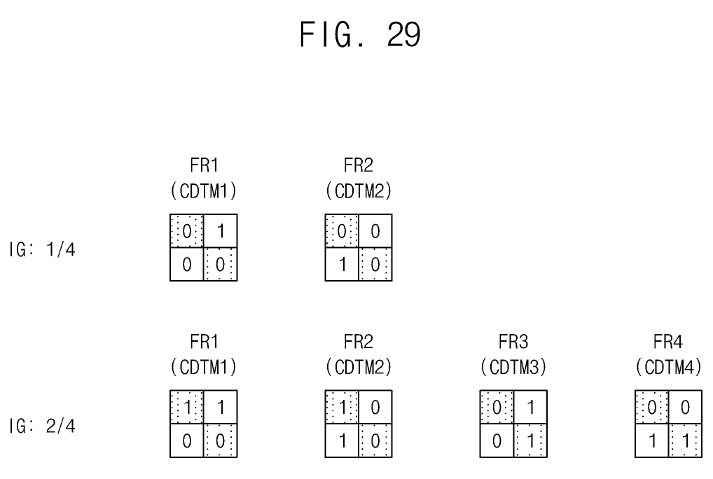

FIG. 26 is a timing diagram showing a second driving method of a demultiplexer 600. FIG. 27 is a circuit diagram showing a luminance of pixels PX1 to PX4 of FIG. 21 in a driving method of FIG. 26. FIG. 28 is a diagram showing an example of a compensation dithering map which compensates for a luminance of pixels PX1 to PX4 of FIG. 21 in a driving method of FIG. 26. FIG. 29 is a diagram showing another example of a compensation dithering map which compensates for a luminance of pixels PX1 to PX4 of FIG. 21 in a driving method of FIG. 26.

Referring to FIGS. 1-29, sequentially, the first switching signal SWS1 may have the turn-on level L_ON, the second switching signal SWS2 may have the turn-on level L_ON, the second switching signal SWS2 may have the turn-on level L_ON, and the first switching signal SWS1 may have the turn-on level L_ON. As such, when the first switching signal SWS1 “A” having the turn-on level L_ON and the second switching signal SWS2 “B” having the turn-on level L_ON are repeated in an order of “ABBA”, the demultiplexer 600 may operate in the second driving method.

In a first period DU1, the output channel OC may output a first data voltage VDATA1. The first switching element SW1 may be turned on in response to the first switching signal SWS1 having the turn-on level L_ON to connect the output channel OC and the first data line DL1. Therefore, the first data voltage VDATA1 may be provided to the first data line DL1. When the first data write gate signal GW1 has the turn-on level L_ON, the first data voltage VDATA1 provided to the first data line DL1 may be provided to the first pixel PX1.

In a second period DU2, the output channel OC may output a second data voltage VDATA2. The second switching element SW2 may be turned on in response to the second switching signal SWS2 having the turn-on level L_ON to connect the output channel OC and the second data line DL2. Therefore, the second data voltage VDATA2 may be provided to the second data line DL2. When the first data write gate signal GW1 has the turn-on level L_ON, the second data voltage VDATA2 provided to the second data line DL2 may be provided to the second pixel PX2.

In a third period DU3, the output channel OC may output a fourth data voltage VDATA4. The second switching element SW2 may be turned on in response to the second switching signal SWS2 having the turn-on level L_ON to connect the output channel OC and the second data line DL2. Therefore, the fourth data voltage VDATA4 may be provided to the second data line DL2. When the second data write gate signal GW2 has the turn-on level L_ON, the fourth data voltage VDATA4 provided to the second data line DL2 may be provided to the fourth pixel PX4.

In a fourth period DU4, the output channel OC may output a third data voltage VDATA3. The first switching element SW1 may be turned on in response to the first switching signal SWS1 having the turn-on level L_ON to connect the output channel OC and the first data line DL1. Therefore, the third data voltage VDATA3 may be provided to the first data line DL1. When the second data write gate signal GW2 has the turn-on level L_ON, the third data voltage VDATA3 provided to the first data line DL1 may be provided to the fourth pixel PX4.

A non-overlapping period of a turn-on period of the first switching signal SWS1 and a turn-on period of the first data write gate signal GW1 among the turn-on period of the first data write gate signal GW1 may be longer than a non-overlapping period of a turn-on period of the second switching signal SWS2 and the turn-on period of the first data write gate signal GW1 among the turn-on period of the first data write gate signal GW1. That is, a time length of a non-overlapping period of the first pixel PX1 may be longer than a time length of a non-overlapping period of the second pixel PX2. Therefore, a luminance of the first pixel PX1 may be less than a luminance of the second pixel PX2.

A non-overlapping period of the turn-on period of the second switching signal SWS2 and a turn-on period of the second data write gate signal GW2 among the turn-on period of the second data write gate signal GW2 may be longer than a non-overlapping period of a turn-on period of the first switching signal SWS1 and a turn-on period of the second data write gate signal GW2 among the turn-on period of the second data write gate signal GW2. That is, a time length of a non-overlapping period of the fourth pixel PX4 may be longer than a time length of a non-overlapping period of the third pixel PX3. Therefore, a luminance of the fourth pixel PX4 may be less than a luminance of the third pixel PX3.

As such, when the display device includes the demultiplexer 600, a problem may occur in which the luminance of the some pixels PX1, PX4 among the pixels PX1, PX2, PX3, PX4 decreases. Therefore, when the display device includes the demultiplexer 600 and performs the temporal spatial dithering, a luminance of a unit area UA may not be constant, and a display quality may not be constant. Specifically, when the demultiplexer 600 operates in the second driving method, the luminance of the first pixel PX1 and the luminance of the fourth pixel PX4 may be small and should be compensated.

The driving controller 200 may compensate for the dithering map DTM to compensate for the luminance of the first pixel PX1 and the luminance of the fourth pixel PX4.

In an embodiment, the driving controller 200 may increase a reference grayscale of the some pixels PX1, PX4 whose luminance decreases and which are included in the dithering map DTM. Specifically, the driving controller 200 may increase a reference grayscale of the first pixel PX1 and a reference grayscale of the fourth pixel PX4 which are included in the dithering map DTM. Accordingly, the first data voltage VDATA1 provided to the first pixel PX1 may increase, and the fourth data voltage VDATA4 provided to the fourth pixel PX4 may increase.

As shown in FIG. 28, for example, an input grayscale IG of a first dithering map DTM1 may be “2/4”. The first dithering map DTM1 may have the first reference grayscale “0” in the first pixel PX1, the second reference grayscale “1” in the second pixel PX2, the second reference grayscale “1” in the third pixel PX3, and the first reference grayscale “0” in the fourth pixel PX4. Here, the first dithering map DTM1 may be a dithering map before compensation. Therefore, the luminance of the first pixel PX1 and the luminance of the fourth pixel PX4 according to the first dithering map DTM1 may be small and should be compensated. Therefore, the driving controller 200 may compensate for the first dithering map DTM1 to generate a first compensation dithering map CDTM1. Here, the first compensation dithering map CDTM1 may be a dithering map after compensation. Specifically, the driving controller 200 may increase the first reference grayscale “0” to the second reference grayscale “1” in the first pixel PX1. The driving controller 200 may increase the first reference grayscale “0” to the second reference grayscale “1” in the fourth pixel PX4. Accordingly, the luminance of the first pixel PX1 and the luminance of the fourth pixel PX4 may be compensated, and even if the display device includes the demultiplexer 600 and performs the temporal spatial dithering, the luminance of the unit area UA may be constant, and the display quality may be constant.

As shown in FIG. 28, for example, an input grayscale IG of a second dithering map DTM2 may be “2/4”. The first dithering map DTM1 may have the first reference grayscale “0” in the first pixel PX1, the second reference grayscale “1” in the second pixel PX2, the first reference grayscale “0” in the third pixel PX3, and the second reference grayscale “1” in the fourth pixel PX4. Here, the first dithering map DTM1 may be the dithering map before compensation. Therefore, the luminance of the first pixel PX1 and the luminance of the fourth pixel PX4 according to the first dithering map DTM1 may be small and should be compensated. Therefore, the driving controller 200 may compensate for the first dithering map DTM1 to generate the first compensation dithering map CDTM1. Here, the first compensation dithering map CDTM1 may be a dithering map after compensation. Specifically, the driving controller 200 may increase the first reference grayscale “0” to the second reference grayscale “1” in the first pixel PX1. The driving controller 200 may increase the second reference grayscale “1” to the third reference grayscale “2” in the fourth pixel PX4. Accordingly, the luminance of the first pixel PX1 and the luminance of the fourth pixel PX4 may be compensated, and even if the display device includes the demultiplexer 600 and performs the temporal spatial dithering, the luminance of the unit area UA may be constant, and the display quality may be constant.

As such, the driving controller 200 may compensate for the dithering map DTM according to a non-overlapping period of a turn-on period of switching signal SWS1, SWS2 and a turn-on period of the data write gate signals GW1, GW2 among the turn-on period of the data write gate signals GW1, GW2 for each of the first to fourth pixels PX1 to PX4. Accordingly, the luminance of the some pixels PX1, PX4 among the pixels PX1, PX2, PX3, PX4 may be compensated, and even if the display device includes the demultiplexer 600 and performs the temporal spatial dithering, the luminance of the unit area UA may be constant, and the display quality may be constant.

In an embodiment, the driving controller 200 may select a compensation dithering map CDTM such that a ratio of a number of pixel PX having the second reference grayscale “1” in the some pixels PX1, PX4 having the reduced luminance may become a target ratio. When the some pixels PX1, PX4 having the reduced luminance have the first reference grayscale “0” or the second reference grayscale “1”, a degree of a luminance reduction in each case may be different. When the ratio of the number of pixel PX having the second reference grayscale “1” in the some pixels PX1, PX4 having the reduced luminance becomes constant at the target ratio, the degree of the luminance reduction of the unit area UA may be constant, and the display quality may be constant.

As shown in FIG. 29, for example, an input grayscale IG of each of first and second compensation dithering maps CDTM1, CDTM2 may be “1/4”. Here, the luminance of the first pixel PX1 and the luminance of the fourth pixel PX4 according to each of the first and second compensation dithering maps CDTM1, CDTM2 may be small. Therefore, the driving controller 200 may select the compensation dithering map CDTM such that the ratio of the number of pixels PX having the second reference grayscale “1” in the first and fourth pixels PX1, PX4 whose luminance decreases may become the target ratio. For example, the target ratio may be “0/2”.

During a first frame FR1, the first compensation dithering map CDTM1 may have the first reference grayscale “0” in the first pixel PX1 and the fourth pixel PX4, and the ratio of the number of pixel PX having the second reference grayscale “1” in the first and fourth pixels PX1, PX4 whose luminance decreases may be “0/2”. During a second frame FR2, the second compensation dithering map CDTM2 may have the first reference grayscale “0” in the first pixel PX1 and the fourth pixel PX4, and the ratio of the number of pixel PX having the second reference grayscale “1” in the first and fourth pixels PX1, PX4 whose luminance decreases may be “0/2”. Accordingly, each of the first and second compensation dithering maps CDTM1, DTM2 may have the constant degree of the compensation reductio of the unit area UA, and the display quality may be constant.

As shown in FIG. 29, for example, an input grayscale IG of each of first, second, third, and fourth compensation dithering maps CDTM1, CDTM2, CDTM3, CDTM4 may be “2/4”. Here, the luminance of the first pixel PX1 and the luminance of the fourth pixel PX4 according to each of the first, second, third, and fourth compensation dithering maps CDTM1, CDTM2, CDTM3, and CDTM4 may be small. Therefore, the driving controller 200 may select the compensation dithering map CDTM such that the ratio of the number of pixels PX having the second reference grayscale “1” in the first and fourth pixels PX1, PX4 whose luminance decreases may become the target ratio. For example, the target ratio may be “1/2”.

During a first frame FR1, the first compensation dithering map CDTM1 may have the second reference grayscale “1” in the first pixel PX1 and the first reference grayscale “0” in the fourth pixel PX4, and the ratio of the number of pixel PX having the second reference grayscale “1” in the first and fourth pixels PX1, PX4 whose luminance decreases may be “1/2”. During a second frame FR2, the second compensation dithering map CDTM2 may have the second reference grayscale “1” in the first pixel PX1 and the first reference grayscale “0” in the fourth pixel PX4, and the ratio of the number of pixel PX having the second reference grayscale “1” in the first and fourth pixels PX1, PX4 whose luminance decreases may be “1/2”. During a third frame FR3, the third compensation dithering map CDTM3 may have the first reference grayscale “0” in the first pixel PX1 and the second reference grayscale “1” in the fourth pixel PX4, and the ratio of the number of pixel PX having the second reference grayscale “1” in the first and fourth pixels PX1, PX4 whose luminance decreases may be “1/2”. During a fourth frame FR4, the fourth compensation dithering map CDTM4 may have the first reference grayscale “0” in the first pixel PX1, and the second reference grayscale “1” in the fourth pixel PX4, and the ratio of the number of pixel PX having the second reference grayscale “1” in the first and fourth pixels PX1, PX4 whose luminance decreases may be “1/2”. Accordingly, each of the first, second, and third fourth compensation dithering maps CDTM1, CDTM2, CDTM3, CDTM4 may have the constant degree of the compensation reduction of the unit area UA, and the display quality may be constant.

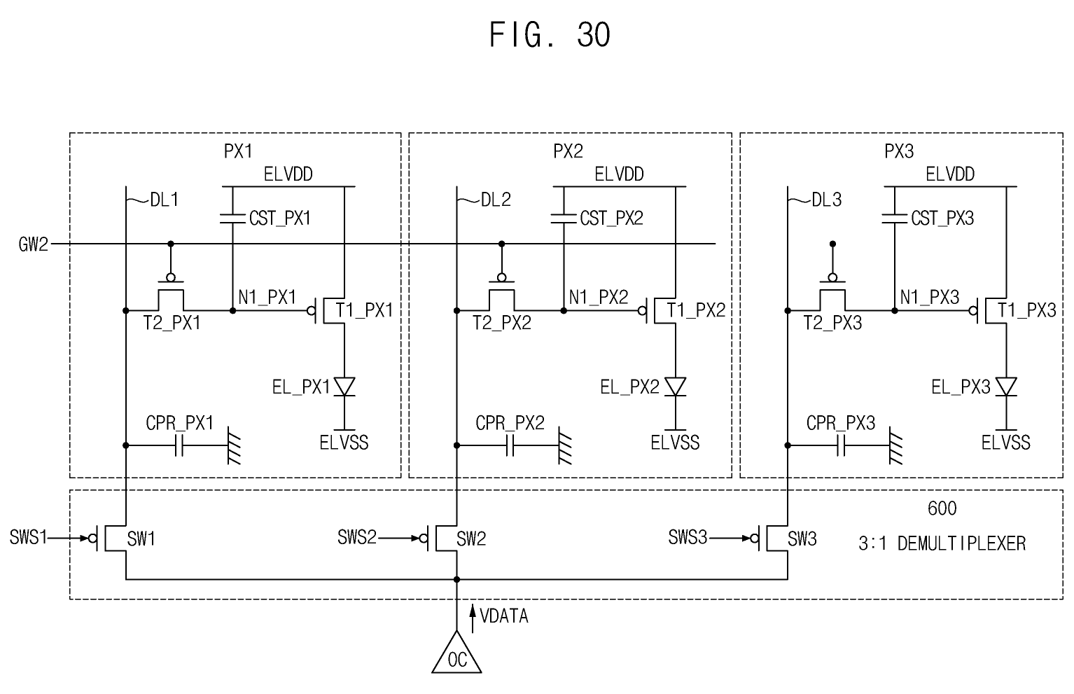

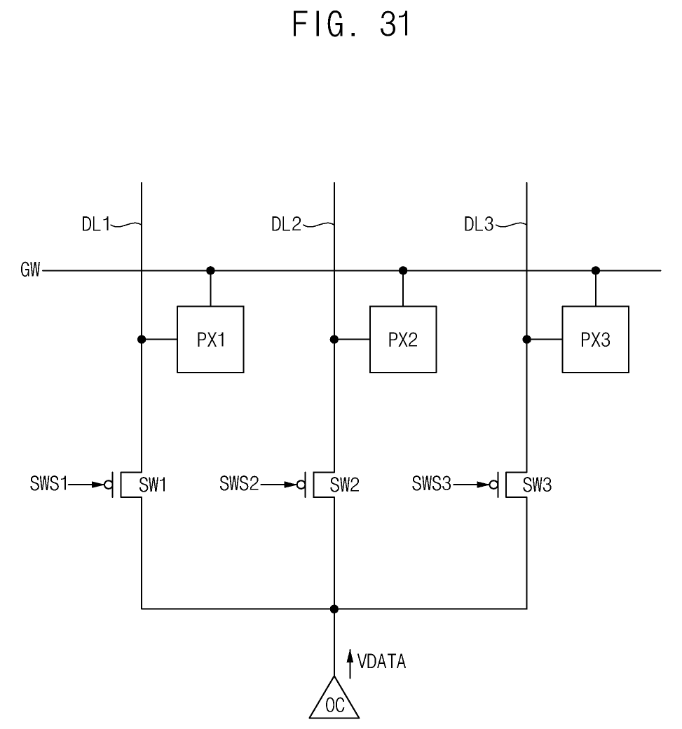

FIGS. 30 and FIG. 31 are circuit diagrams showing pixels PX1, PX2, PX3 included in a same pixel row, a demultiplexer 600 connected to the pixels PX1, PX2, PX3, and an output channel OC connected to the demultiplexer 600 of FIG. 1.

Referring to FIGS. 1-31, a same pixel row may include a plurality of pixels PX1, PX2, PX3. For example, the same pixel row may include a first pixel PX1, a second pixel PX2, and a third pixel PX3. The first pixel PX1, the second pixel PX2, and the third pixel PX3 may be disposed adjacent to each other. FIG. 30 shows that the same pixel row includes three pixels PX1, PX2, PX3, but the present inventive concept is not limited thereto.

The first pixel PX1 may include a first transistor T1_PX1, a second transistor T2_PX1, a storage capacitor CST_PX1, and a light emitting element EL_PX1. The first transistor T1_PX1 may include a gate electrode connected to a first node N1_PX1, a first electrode receiving a first power supply voltage ELVDD, and a second electrode. The second transistor T2_PX1 may include a gate electrode receiving a data write gate signal GW, a first electrode connected to a first data line DL1, and a second electrode connected to the first node N1_PX1. The storage capacitor CST_PX1 may include a first electrode receiving the first power supply voltage ELVDD and a second electrode connected to the first node N1_PX1. The light emitting element EL_PX1 may include an anode electrode connected to the second electrode of the first transistor T1_PX1 and a cathode electrode receiving a second power supply voltage ELVSS. The first pixel PX1 may further include a parasitic capacitor CPR_PX1. The parasitic capacitor CPR_PX1 may be connected to the first data line DL1.

The second pixel PX2 may include a first transistor T1_PX2, a second transistor T2_PX2, a storage capacitor CST_PX2, and a light emitting element EL_PX2. The first transistor T1_PX2 may include a gate electrode connected to a first node N1_PX2, a first electrode receiving the first power supply voltage ELVDD, and a second electrode. The second transistor T2_PX2 may include a gate electrode receiving the data write gate signal GW, a first electrode connected to a second data line DL2, and a second electrode connected to the first node N1_PX2. The storage capacitor CST_PX2 may include a first electrode receiving the first power supply voltage ELVDD and a second electrode connected to the first node N1_PX2. The light emitting element EL_PX2 may include an anode electrode connected to the second electrode of the first transistor T1_PX2 and a cathode electrode receiving the second power supply voltage ELVSS. The second pixel PX2 may further include a parasitic capacitor CPR_PX2. The parasitic capacitor CPR_PX2 may be connected to the second data line DL2.

The third pixel PX3 may include a first transistor T1_PX3, a second transistor T2_PX3, a storage capacitor CST_PX3, and a light emitting element EL_PX3. The first transistor T1_PX3 may include a gate electrode connected to a first node N1_PX3, a first electrode receiving the first power supply voltage ELVDD, and a second electrode. The second transistor T2_PX3 may include a gate electrode receiving the data write gate signal GW, a first electrode connected to a third data line DL3, and a second electrode connected to the first node N1_PX3. The storage capacitor CST_PX3 may include a first electrode receiving the first power supply voltage ELVDD and a second electrode connected to the first node N1_PX3. The light emitting element EL_PX3 may include an anode electrode connected to the second electrode of the first transistor T1_PX3 and a cathode electrode receiving the second power supply voltage ELVSS. The third pixel PX3 may further include a parasitic capacitor CPR_PX3. The parasitic capacitor CPR_PX3 may be connected to the third data line DL3.

A demultiplexer 600 may selectively connect an output channel OC to each of the first data line DL1, the second data line DL2, and the third data line DL3. For example, the demultiplexer 600 may be a 3:1 demultiplexer and may include a first switching element SW1, a second switching element SW2, and a third switching element SW3.

In an embodiment, the first switching element SW1, the second switching element SW2, and the third switching element SW3 may be the P-type transistors. For example, the P-type transistors may be PMOS transistors.

The first switching element SW1 may be turned on in response to a first switching signal SWS1 having the turn-on level L_ON to connect the output channel OC and the first data line DL1. The second switching element SW2 may be turned on in response to a second switching signal SWS2 having the turn-on level L_ON to connect the output channel OC and the second data line DL2. The third switching element SW3 may be turned on in response to a third switching signal SWS3 having the turn-on level L_ON to connect the output channel OC and the third data line DL3.

The output channel OC may be connected to the first switching element SW1, the second switching element SW2, and the third switching element SW3. The output channel OC may output a data voltage VDATA.

When the output channel OC outputs the data voltage VDATA and the first switching element SW1 is turned on in response to the first switching signal SWS1 having the turn-on level L_ON, the data voltage VDATA output from the output channel OC may be provided to the first data line DL1. When the data write gate signal GW has the turn-on level L_ON, the data voltage VDATA provided to the first data line DL1 may be provided to the first pixel PX1.

When the output channel OC outputs the data voltage VDATA and the second switching element SW2 is turned on in response to the second switching signal SWS2 having the turn-on level L_ON, the data voltage VDATA output from the output channel OC may be provided to the second data line DL2. When the data write gate signal GW has the turn-on level L_ON, the data voltage VDATA provided to the second data line DL2 may be provided to the second pixel PX2.

When the output channel OC outputs the data voltage VDATA and the third switching element SW3 is turned on in response to the third switching signal SWS3 having the turn-on level L_ON, the data voltage VDATA output from the output channel OC may be provided to the third data line DL3. When the data write gate signal GW has the turn-on level L_ON, the data voltage VDATA provided to the third data line DL3 may be provided to the third pixel PX3.

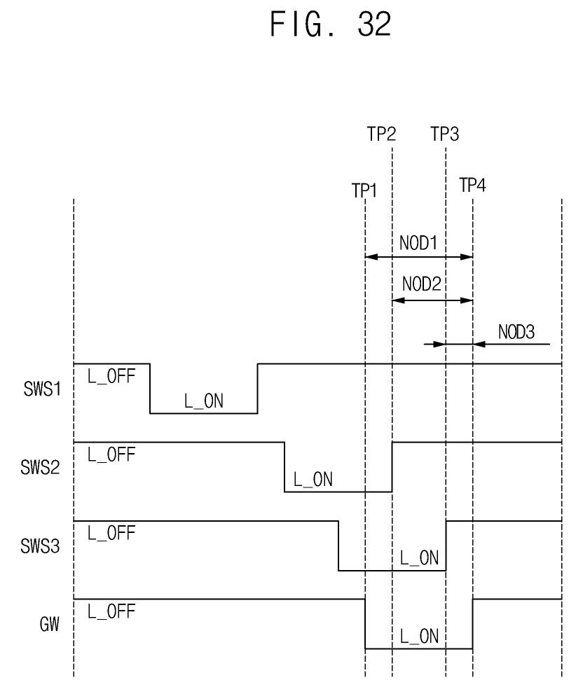

FIG. 32 is a timing diagram showing non-overlapping periods NOD1, NOD2, NOD3 according to a data write gate signal GW and switching signals SWS1, SWS2, SW3 of FIG. 30.

Referring to FIGS. 1-32, a period where a gate-source voltage of the first transistor T1_PX1 of the first pixel PX1 is stored in the parasitic capacitor CPR_PX1 of the first pixel PX1 and is affected by a continuously decreasing data voltage VDATA may be a first non-overlapping period NOD1. A period where a gate-source voltage of the first transistor T1_PX2 of the second pixel PX2 is stored in the parasitic capacitor CPR_PX2 of the second pixel PX2 and is affected by a continuously decreasing data voltage VDATA may be a second non-overlapping period NOD2. A period where a gate-source voltage of the first transistor T1_PX3 of the third pixel PX3 is stored in the parasitic capacitor CPR_PX3 of the third pixel PX3 and is affected by a continuously decreasing data voltage VDATA may be a third non-overlapping period NOD3.

The first non-overlapping period NOD1 may be a non-overlapping period of a turn-on period of the first switching signal SWS1 and a turn-on period of the data write gate signal GW among the turn-on period of the data write gate signal GW. The first non-overlapping period NOD1 may be a period between a first time point TP1 and a fourth time point TP4.

The second non-overlapping period NOD2 may be a non-overlapping period of a turn-on period of the second switching signal SWS2 and the turn-on period of the data write gate signal GW among the turn-on period of the data write gate signal GW. The second non-overlapping period NOD2 may be a period between a second time point TP2 and the fourth time point TP4.

The third non-overlapping period NOD3 may be a non-overlapping period of a turn-on period of the third switching signal SWS3 and the turn-on period of the data write gate signal GW among the turn-on period of the data write gate signal GW. The third non-overlapping period NOD3 may be a period between a third time point TP3 and the fourth time point TP4.

For example, a time length of the first non-overlapping period NOD1 may be longer than a time length of the second non-overlapping period NOD2, and the time length of the second non-overlapping period NOD2 may be longer than a time length of the third non-overlapping period NOD3. In this case, the gate-source voltage of the first transistor T1_PX1 of the first pixel PX1 should be compensated more than the gate-source voltage of the first transistor T1_PX2 of the second pixel PX2. The gate-source voltage of the first transistor T1_PX2 of the second pixel PX2 should be compensated more than the gate-source voltage of the first transistor T1_PX3 of the third pixel PX3.

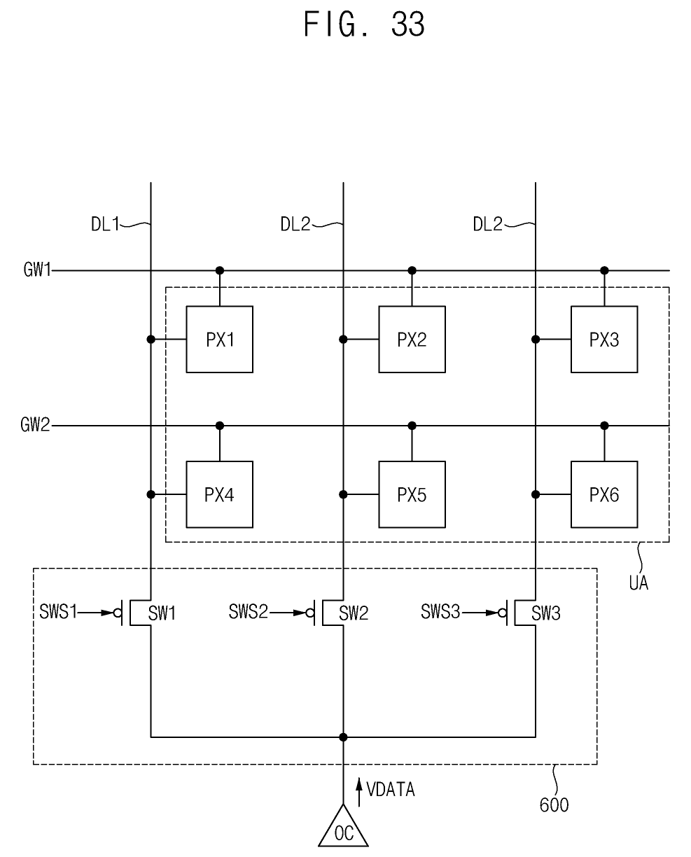

FIG. 33 is a circuit diagram showing pixels PX1 to PX6 included in a unit area UA, a demultiplexer 600 connected to the pixels PX1 to PX6, and an output channel OC connected to the demultiplexer 600.

Referring to FIGS. 1-33, the unit area UA may include 2×3 pixels PX1 to PX6. For example, the unit area UA may include first to sixth pixels PX1 to PX6. FIG. 33 shows that the unit area UA includes six pixels PX1 to PX6, but the present inventive concept is not limited thereto.

The first pixel PX1 and the fourth pixel PX4 may be connected to a first data line DL1. The second pixel PX2 and the fifth pixel PX5 may be connected to a second data line DL2. The third pixel PX3 and the sixth pixel PX6 may be connected to a third data line DL3. The first pixel PX1, the second pixel PX2, and the third pixel PX3 may receive a first data write gate signal GW1. The fourth pixel PX4, the fifth pixel PX5, and the sixth pixel PX6 may receive a second data write gate signal GW2.

A demultiplexer 600 may selectively connect an output channel OC to each of the first data line DL1, the second data line DL2, and the third data line DL3. For example, the demultiplexer 600 may be a 3:1 demultiplexer and may include a first switching element SW1, a second switching element SW2, and a third switching element SW3.

In an embodiment, the first switching element SW1, the second switching element SW2, and the third switching element SW3 may be the P-type transistors. For example, the P-type transistor may be the PMOS transistor.

The first switching element SW1 may be turned on in response to a first switching signal SWS1 having the turn-on level L_ON to connect the output channel OC and the first data line DL1. The second switching element SW2 may be turned on in response to a second switching signal SWS2 having the turn-on level L_ON to connect the output channel OC and the second data line DL2. The third switching element SW3 may be turned on in response to a third switching signal SWS3 having the turn-on level L_ON to connect the output channel OC and the third data line DL3.

The output channel OC may be connected to the first switching element SW1, the second switching element SW2, and the third switching element SW3, and may output a data voltage VDATA.

When the output channel OC outputs the data voltage VDATA and the first switching element SW1 is turned on in response to the first switching signal SWS1 having the turn-on level L_ON, the data voltage VDATA output from the output channel OC may be provided to the first data line DL1. When the first data write gate signal GW1 has the turn-on level L_ON, the data voltage VDATA provided to the first data line DL1 may be provided to the first pixel PX1. When the second data write gate signal GW2 has the turn-on level L_ON, the data voltage VDATA provided to the first data line DL1 may be provided to the fourth pixel PX4.

When the output channel OC outputs the data voltage VDATA and the second switching element SW2 is turned on in response to the second switching signal SWS2 having the turn-on level L_ON, the data voltage VDATA output from the output channel OC may be provided to the second data line DL2. When the first data write gate signal GW1 has the turn-on level L_ON, the data voltage VDATA provided to the second data line DL2 may be provided to the second pixel PX2. When the second data write gate signal GW2 has the turn-on level L_ON, the data voltage VDATA provided to the second data line DL2 may be provided to the fifth pixel PX5.

When the output channel OC outputs the data voltage VDATA and the third switching element SW3 is turned on in response to the third switching signal SWS3 having the turn-on level L_ON, the data voltage VDATA output from the output channel OC may be provided to the third data line DL3. When the first data write gate signal GW1 has the turn-on level L_ON, the data voltage VDATA provided to the third data line DL3 may be provided to the third pixel PX3. When the second data write gate signal GW2 has the turn-on level L_ON, the data voltage VDATA provided to the third data line DL3 may be provided to the sixth pixel PX6.

As such, the driving controller 200 may compensate for the dithering map DTM according to a non-overlapping period of a turn-on period of switching signals SWS1, SWS2, SW3 and a turn-on period of data write gate signals GW1, GW2 among the turn-on period of the data write gate signals GW1, GW2 for each of the first to sixth pixels PX1 to PX6. Accordingly, a luminance of some pixels of the pixels PX1, PX2, PX3, PX4 may be compensated, and even if the display device includes the demultiplexer 600 and performs the temporal spatial dithering, the luminance of the unit area UA may be constant, and the display quality may be constant.

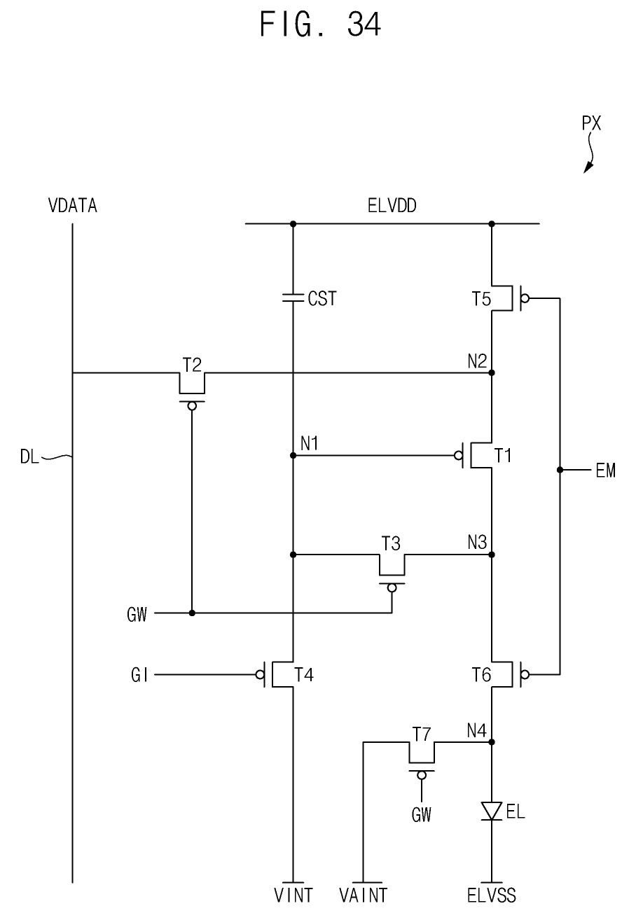

FIG. 34 is a circuit diagram showing an example of a pixel PX of a display panel 100 of FIG. 1.

Referring to FIGS. 1-34, the contents described in FIGS. 1-33 may be applied not only to the pixel PX of FIG. 2 but also to any pixel.

For example, a pixel PX of FIG. 34 may include a first transistor T1, a second transistor T2, a third transistor T3, a fourth transistor T4, a fifth transistor T5, a sixth transistor T6, and a seventh transistor T7.

In an embodiment, the first transistor T1, the second transistor T2, the fifth transistor T5, the sixth transistor T6, and the seventh transistor T7 may be the P-type transistors. For example, the P-type transistors may be PMOS transistors.

The first transistor T1 may include a gate electrode connected to a first node N1, a first electrode connected to a second node N2, and a second electrode connected to a third node N3. The first transistor T1 may be turned on based on a voltage of the first node N1 and a voltage of the second node N2 to generate a driving current. Specifically, the first transistor T1 may generate the driving current based on a difference between the voltage of the first node N1 and the voltage of the second node N2. Therefore, as the difference between the voltage of the first node N1 and the voltage of the second node N2 is large, a magnitude of the driving current may be large. For example, the first transistor T1 may be referred to as a driving transistor.

The second transistor T2 may include a gate electrode receiving a data write gate signal GW, a first electrode connected to a data line DL transmitting a data voltage VDATA, and a second electrode connected to the second node N2. The second transistor T2 may be turned on in response to a data write gate signal GW having the turn-on level L_ON to provide the data voltage VDATA to the second node N2. For example, the second transistor T2 may be referred to as a data write transistor.

The third transistor T3 may include a gate electrode receiving the data write gate signal GW, a first electrode connected to the first node N1, and a second electrode connected to the third node N3. The third transistor T3 may be turned on in response to the data write gate signal GW having the turn-on level L_ON to connect the first node N1 and the third node N3 to each other. That is, the third transistor T3 may be turned on in response to the data write gate signal GW having the turn-on level L_ON to diode-connect the first transistor T1. For example, the third transistor T3 may be referred to as a compensation transistor.

The fourth transistor T4 may include a gate electrode receiving an initialization gate signal GI, a first electrode receiving an initialization voltage VINT, and a second electrode connected to the first node N1. The fourth transistor T4 may be turned on in response to the initialization gate signal GI having the turn-on level L_ON to provide the initialization voltage VINT to the first node N1. For example, the fourth transistor T4 may be referred to as an initialization transistor.

The fifth transistor T5 may include a gate electrode receiving an emission signal EM, a first electrode receiving a first power supply voltage ELVDD, and a second electrode connected to the second node N2. The sixth transistor T6 may include a gate electrode receiving the emission signal EM, a first electrode connected to the third node N3, and a second electrode connected to the fourth node N4. The fifth transistor T5 and the sixth transistor T6 may be turned on in response to an emission signal EM having the turn-on level L_ON to provide the driving current to the light emitting element EL. For example, the fifth transistor T5 may be referred to as a first light emitting control transistor, and the sixth transistor T6 may be referred to as a second light emitting control transistor.

The seventh transistor T7 may include a gate electrode receiving the data write gate signal GW, a first electrode receiving an anode initialization voltage VAINT, and a second electrode connected to the fourth node N4. The seventh transistor T7 may be turned on in response to the data write gate signal GW having the turn-on level L_ON to provide the anode initialization voltage VAINT to the fourth node N4. For example, the seventh transistor T7 may be referred to as an anode initialization transistor.

The storage capacitor CST may include a first electrode receiving the first power supply voltage ELVDD and a second electrode connected to the first node N1. The storage capacitor CST may store the data voltage VDATA.

The light emitting element EL may include an anode electrode connected to the fourth node N4 and a cathode electrode receiving a second power supply voltage ELVSS. The light emitting element EL may emit a light based on the driving current. As the magnitude of the driving current is large, a luminance corresponding to a light emission intensity of the light emitting element EL may be large.

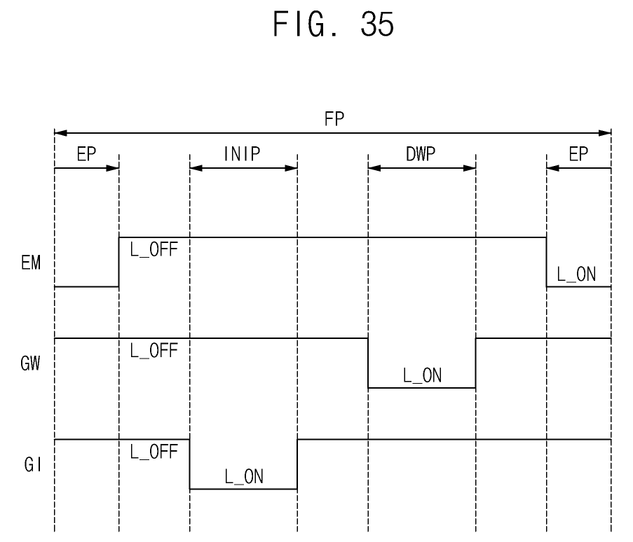

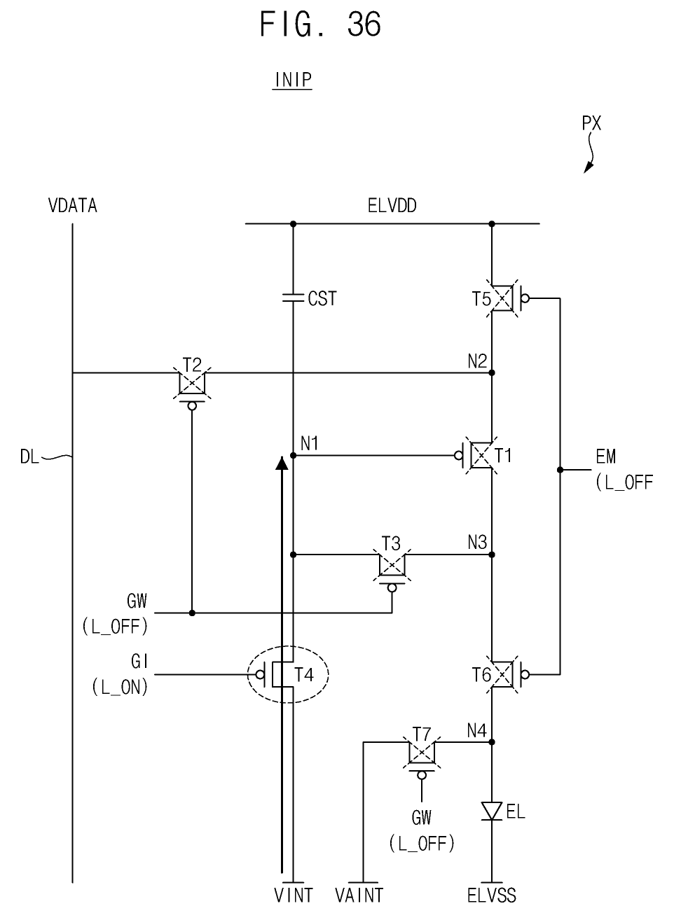

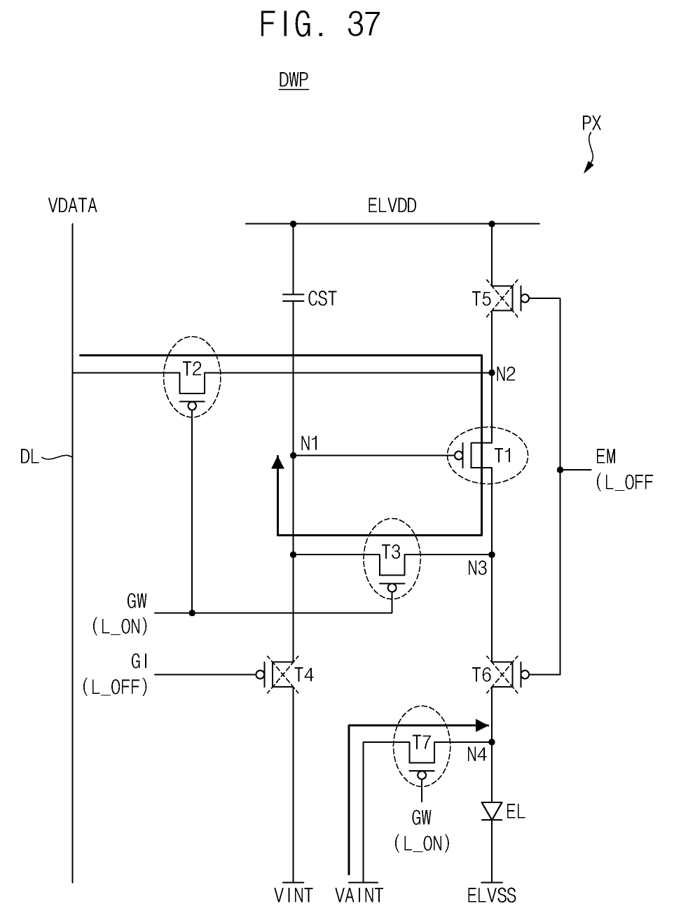

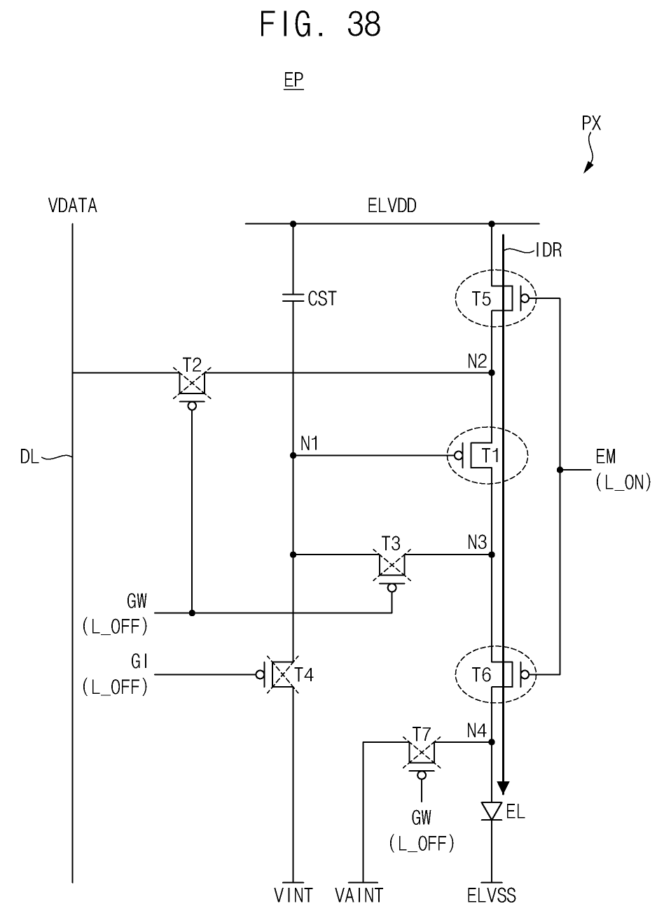

FIG. 35 is a timing diagram showing an example of an operation of a pixel PX of FIG. 34. FIG. 36 is a circuit diagram showing an operation of a pixel PX of FIG. 34 in an initialization period INIP of FIG. 35. FIG. 37 is a circuit diagram showing an operation of a pixel PX of FIG. 34 in a data write period DWP of FIG. 35. FIG. 38 is a circuit diagram showing an operation of a pixel PX of FIG. 34 in a light emission period EP of FIG. 35.

Referring to FIGS. 1-38, in an initialization period INIP, the emission signal EM may have a turn-off level L_OFF, the data write gate signal GW may have the turn-off level L_OFF, and the initialization gate signal GI may have the turn-on level L_ON.

The fourth transistor T4 may be turned on in response to the initialization gate signal GI having the turn-on level L_ON to provide the initialization voltage VINT to the first node N1. Therefore, the voltage of the first node N1 may be initialized to the initialization voltage VINT.

In the data write period DWP, the emission signal EM may have the turn-off level L_OFF, the data write gate signal GW may have the turn-on level L_ON, and the initialization gate signal GI may have the turn-off level L_OFF.

The second transistor T2 may be turned on in response to the data write gate signal GW having the turn-on level L_ON to provide the data voltage VDATA to the second node N2. The first transistor T1 may be turned on based on the voltage of the first node N1 and the voltage of the second node N2.

The third transistor T3 may be turned on in response to the data write gate signal GW having the turn-on level L_ON to diode-connect the first transistor T1.

The data voltage VDATA may be provided to the first node N1 through the first transistor T1 and the third transistor T3.

The seventh transistor T7 may be turned on in response to the data write gate signal GW having the turn-on level L_ON to provide the anode initialization voltage VAINT to the fourth node N4. Therefore, a voltage of the fourth node N4 may be initialized to the anode initialization voltage VAINT.

In the light emission period EP, the emission signal EM may have the turn-on level L_ON, the data write gate signal GW may have the turn-off level L_OFF, and the initialization gate signal GI may have the turn-off level L_OFF.

The first transistor T1 may be turned on based on the voltage of the first node N1 and the voltage of the second node N2 to generate the driving current IDR.

The fifth transistor T5 may be turned on in response to the emission signal EM having the turn-on level L_ON. Therefore, the driving current IDR may be provided to the light emitting element EL, and the light emitting element EL may emit a light based on the driving current IDR.

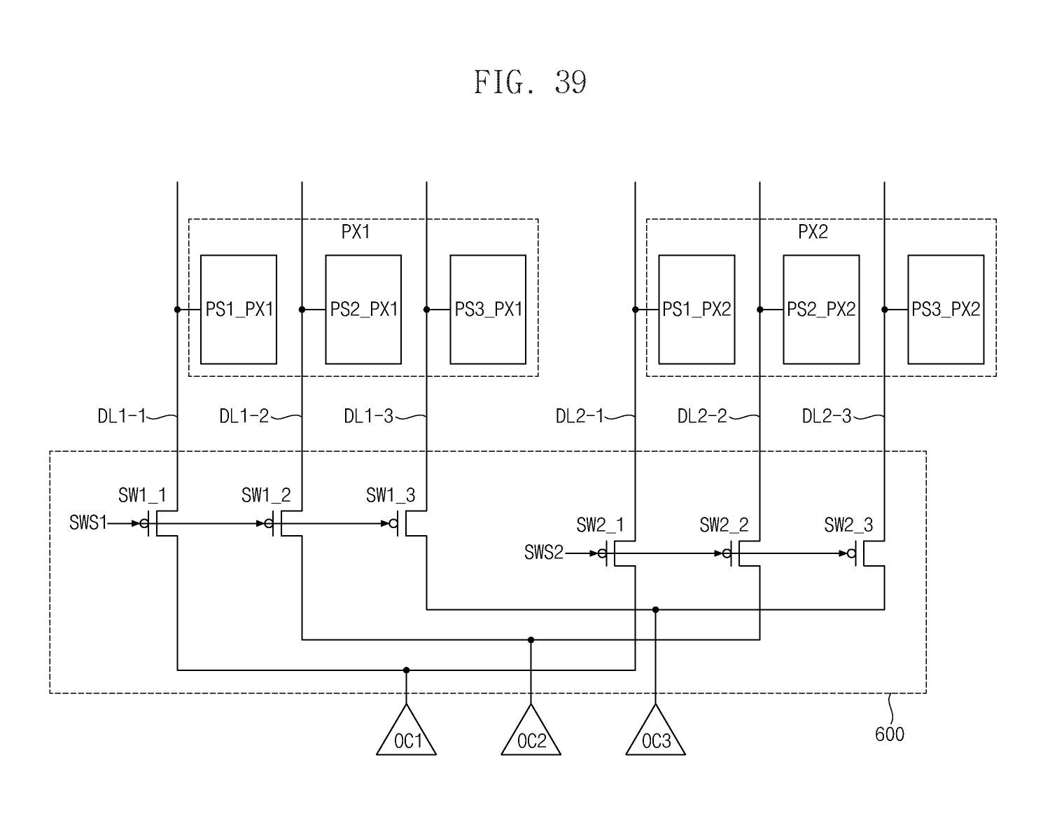

FIG. 39 is a circuit diagram showing pixels PX1, PX2 included in a same pixel row, a demultiplexer 600 connected to the pixels PX1, PX2, and an output channel OC connected to the demultiplexer 600 of FIG. 1.

Referring to FIGS. 1-39 , a same pixel row may include a plurality of pixels PX1, PX2. For example, the same pixel row may include a first pixel PX1 and a second pixel PX2. The first pixel PX1 and the second pixel PX2 may be disposed adjacent to each other. Each of the first pixel PX1 and the second pixel PX2 may include first color sub-pixels PS1_PX1, PS1_PX2, second color sub-pixels PS2_PX1, PS2_PX2, and third color sub-pixels PS3_PX1, PS3_PX2. In an embodiment, the first color sub-pixels PS1_PX1, PS1_PX2may display a red, the second color sub-pixels PS2_PX1, PS2_PX2 may display a green, and the third color sub-pixels PS3_PX1, PS3_PX2 may display a blue. FIG. 39 show that the same pixel row includes two pixels PX1, PX2, but the present inventive concept is not limited thereto.

The first color sub-pixel PS1_PX1 of the first pixel PX1 may be connected to a first-first data line DL1-1. The second color sub-pixel PS2_PX1 of the first pixel PX1 may be connected to a first-second data line DL1-2. The third color sub-pixel PS3_PX1 of the first pixel PX1 may be connected to a first-third data line DL1-3. The first color sub-pixel PS1_PX2 of the second pixel PX2 may be connected to a second-first data line DL2-1. The second color sub-pixel PS2_PX2 of the second pixel PX2 may be connected to a second-second data line DL2-2. The third color sub-pixel PS3_PX2 of the second pixel PX2 may be connected to a second-third data line DL2-3.

A demultiplexer 600 may selectively connect a first output channel OC1 to each of the first-first data line DL1-1 and the second-first data line DL2-1, may selectively connect a second output channel OC2 to each of the first-second data line DL1-2 and the second-second data line DL2-2, and may selectively connect a third output channel OC3 to each of the first-third data line DL1-3 and the second-third data line DL2-3. For example, the demultiplexer 600 may be a 2:1 demultiplexer and may include a first-first switching element SW1_1, a first-second switching element SW1_2, a first-third switching element SW1_3, a second-first switching element SW2_1, a second-second switching element SW2_2, and a second-third switching element SW2_3.

In an embodiment, the first-first switching element SW1_1, the first-second switching element SW1_2, the first-third switching element SW1_3, the second-first switching element SW2_1, the second-second switching element SW2_2, and the second-third switching element SW2_3 may be P-type transistors. For example, the P-type transistors may be the PMOS transistors.

The first-first switching element SW1_1 may be turned on in response to a first switching signal SWS1 having the turn-on level L_ON to connect the first output channel OC1 and the first-first data line DL1-1. The first-second switching element SW1_2 may be turned on in response to the first switching signal SWS1 having the turn-on level L_ON to connect the second output channel OC2 and the first-second data line DL1-2. The first-third switching element SW1_3 may be turned on in response to the first switching signal SWS1 having the turn-on level L_ON to connect the third output channel OC3 and the first-third data line DL1-3. The second-first switching element SW2_1 may be turned on in response to a second switching signal SWS2 having the turn-on level L_ON to connect the first output channel OC1 and the second-first data line DL2-1. The second- second switching element SW2_2 may be turned on in response to the second switching signal SWS2 having the turn-on level L_ON to connect the second output channel OC2 and the second-second data line DL2-2. The third-third switching element SW3_3 may be turned on in response to the second switching signal SWS2 having the turn-on level L_ON to connect the third output channel OC3 and the second-third data line DL2-3.

The first output channel OC1 may be connected to the first-first switching element SW1_1 and the second-first switching element SW2_1 and may output the data voltage VDATA. The second output channel OC2 may be connected to the first-second switching element SW1_2 and the second-second switching element SW2_2 and may output the data voltage VDATA. The third output channel OC3 may be connected to the first-third switching element SW1_3 and the second-third switching element SW2_3 and may output the data voltage VDATA.

The contents described in FIGS. 1-39 may also be applied to pixels PX1, PX2 including the first to third color sub-pixels PS1_PX1, PS2_PX1, PS3_PX1, PS1_PX2, PS2_PX2, PS3_PX2. Accordingly, a color coordinate imbalance may be prevented, and a display quality of a display device may be maintained.

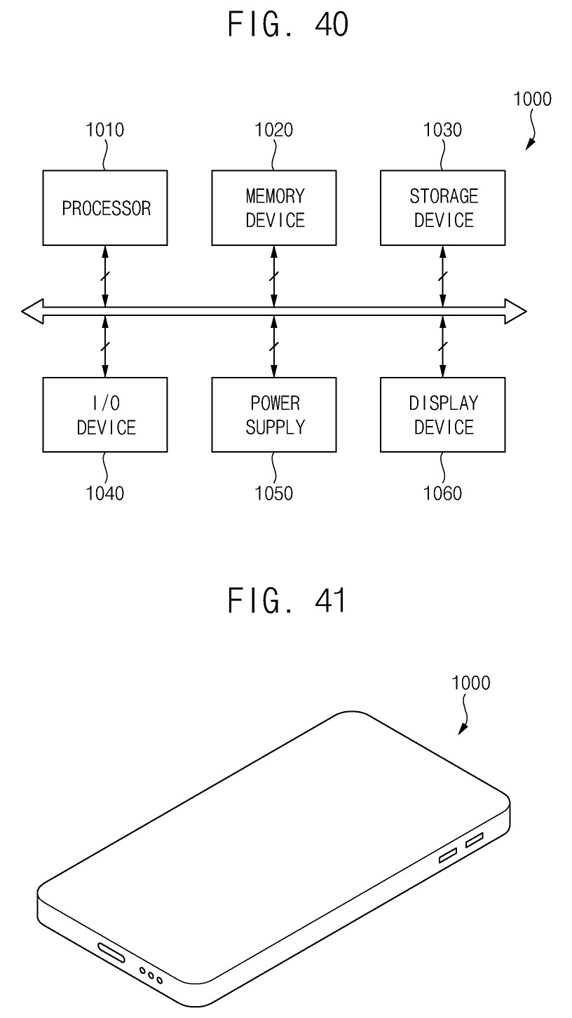

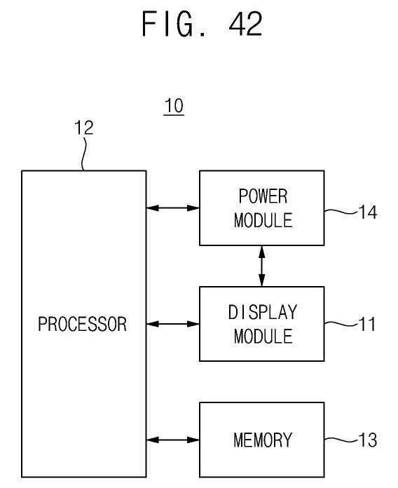

FIG. 40 is a block diagram showing an electronic device 1000 according to an embodiment of the present inventive concept. FIG. 41 is a diagram showing an example in which an electronic device 1000 of FIG. 40 is implemented as a smart phone.

Referring to FIGS. 1-41, an electronic device 1000 may include a processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

In an embodiment, as shown in FIG. 41, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

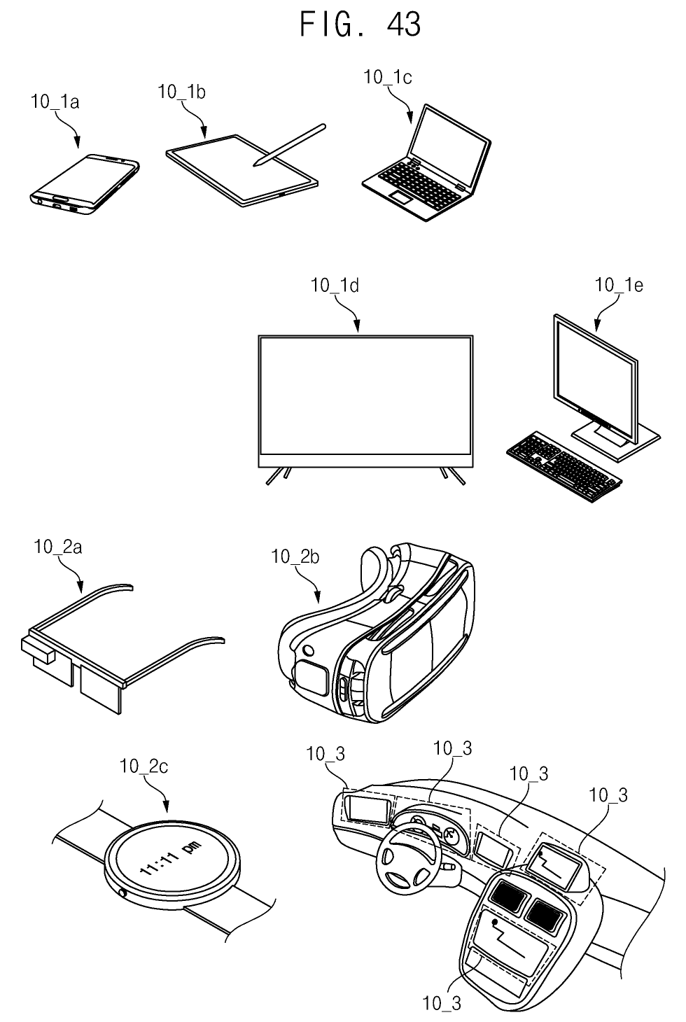

FIG. 42 is a block diagram showing an electronic device 10 according to an embodiment of the present inventive concept. FIG. 43 is schematic diagrams showing electronic devices of FIG. 42.

Referring to FIG. 42, the electronic device 10 according to an embodiment may include a display module 11, a processor 12, a memory 13 and a power module 14.

The display device according to the embodiment of the present inventive concept may be applied to various electronic devices.

In an embodiment, the electronic device 10 may include the display device of FIG. 1. An operation of the display device included in the electronic device 10 may be the same as the operation of the display device explained referring to FIGS. 1-39. The electronic device 10 may further include a module or an device having additional functions in addition to the display device.

The processor 12 may include at least one of a central processing unit (CPU), an application processor (AP), a graphic processing unit (GPU), a communication processor (CP), an image signal processor (ISP) and a controller.

In an embodiment, the processor 12 may provide the input control signal CONT of FIG. 1 and the input image data IMG of FIG. 1 to the driving controller 200 included in the display device of FIG. 1.

In an embodiment, the processor 12 may be divided into two or more in a functional or structural perspective. For example, the processor 12 may include a main processor, which is a first driving chip type, including the central processing unit and an auxiliary processor, which is a second driving chip type, including a controller receiving an image signal from the main processor and processing the image signal to match interface specifications of the display module 11. For example, the auxiliary processor may include the driving controller 200 included in the display device of FIG. 1. Thus, the main processor may provide the input control signal CONT of the FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. Data information required for the operation of the processor 12 or the display module 11 may be stored in the memory 13. When the processor 12 executes an application stored in the memory 13, the input control signal CONT and/or the input image data IMG may be transmitted to the display module 11 and the display module 11 may process the input control signal CONT and/or the input image data IMG and may output image information through a display area.

The power module 14 may include a power supply module, such as a power adapter or a battery device, and a power conversion module converting power supplied by the power supply module to generate a power required for the operation of the electronic device 10.

At least one of the elements of the electronic device 10 may be included in the display device according to embodiments of the present inventive concept. In addition, a part of a single functional module may be included in the display device and another part of the single functional module may be disposed out of the display device. For example, the display module 11 may be included in the display device but the processor 12, the memory 13 and the power module 14 may be included in another device in the electronic device 10 which is not the display device.

Referring to FIG. 43, the various electronic devices including the display device according to the present embodiments may include electronic devices for displaying image such as a smartphone 10_1a, a tablet PC 10_1b, a laptop 10_1c, a television 10_1d, a desktop monitor 10_1e, wearable electronic devices including a display module such as smart glasses 10_2a, a head mounted display 10_2b and a smart watch 10_2c and vehicle electronic devices 10_3 including display modules such as a CID (center information display), a room mirror display disposed on an instrument panel, center fascia, and a dashboard of a vehicle. The electronic device 10 may not be limited to the electronic devices for displaying image, the wearable electronic devices and the vehicle electronic devices 10_3.

According to the driver, the display device including the driver and the electronic device including the driver of the present embodiment as explained above, the power consumption of the display device may be reduced.

The foregoing is illustrative of the present inventive concept and is not to be construed as limiting thereof. Although embodiments of the present inventive concept have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific example embodiments disclosed, and that modifications to the disclosed example embodiments, as well as other example embodiments, are intended to be included within the scope of the appended claims. The present inventive concept is defined by the following claims, with equivalents of the claims to be included therein.

What is claimed is:

1. A display device comprising:
a display panel including a first pixel connected to a first data line and a first gate line, a second pixel connected to the first data line and a second gate line, a third pixel connected to a second data line and the first gate line, and a fourth pixel connected to the second data line and the second gate line;
a data driver including an output channel providing a data voltage to each of the first data line and the second data line;
a gate driver configured to provide a first gate signal to the first gate line and a second gate signal to the second gate line;
a demultiplexer including a first switching element configured to connect the first data line and the output channel in response to a first switching signal and a second switching element configured to connect the second data line and the output channel in response to a second switching signal; and
a driving controller configured to control the data driver, the gate driver, and the demultiplexer, and configured to compensate for input image data based on a dithering map having a first reference grayscale less than an input grayscale or a second reference grayscale greater than the input grayscale for each of the first to fourth pixels,
wherein the driving controller is configured to compensate for the input image data based on the dithering map which is compensated for according to a non-overlapping period of a turn-on period of a switching signal and a turn-on period of a gate signal for each of the first to fourth pixels.

2. The display device of claim 1, wherein a luminance of each of the first to fourth pixels is different according to a time length of the non-overlapping period.

3. The display device of claim 2, wherein, as the time length of the non-overlapping period is long, the luminance of each of the first to fourth pixels decreases.

4. The display device of claim 1, wherein, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller is configured to increase a reference grayscale of the first pixel and a reference grayscale of the second pixel.

5. The display device of claim 1, wherein, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller is configured to increase a reference grayscale of the first pixel and a reference grayscale of the fourth pixel.

6. The display device of claim 1, wherein, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller is configured to select the dithering map, thereby selecting a selected dithering map, such that a ratio of a number of pixels having the second reference grayscale in the first pixel and the third pixel becomes a target ratio, and
wherein the driving controller is configured to compensate for the input image data based on the selected dithering map.

7. The display device of claim 1, wherein, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller is configured to select the dithering map, thereby selecting a selected dithering map, such that a ratio of a number of pixels having the second reference grayscale in the first pixel and the fourth pixel becomes a target ratio, and
wherein the driving controller is configured to compensate for the input image data based on the selected dithering map.

8. The display device of claim 1, wherein the driving controller is configured to compensate for the input image data based on a dithering map which changes during a plurality of frames.

9. The display device of claim 8, wherein, when the input grayscale is less than a threshold grayscale, the driving controller is configured to compensate for the input image data based on the dithering map which changes during the plurality of frames.

10. The display device of claim 1, wherein, in a turn-on period of the first switching signal, the data voltage output from the output channel is provided to the first data line.

11. The display device of claim 10, wherein, in a turn-on period of the first gate signal, the data voltage of the first data line is provided to the first pixel, and in a turn-on period of the second gate signal, the data voltage of the first data line is provided to the second pixel.

12. The display device of claim 1, wherein, in a turn-on period of the second switching signal, the data voltage output from the output channel is provided to the second data line.

13. The display device of claim 12, wherein, in a turn-on period of the first gate signal, the data voltage of the second data line is provided to the third pixel, and in a turn-on period of the second gate signal, the data voltage of the second data line is provided to the fourth pixel.

14. The display device of claim 1, wherein the display panel further includes a fifth pixel connected to a third data line and the first gate line and a sixth pixel connected to the third data line and the second gate line,
wherein the output channel is configured to provide the data voltage to the third data line,
wherein the demultiplexer further includes a third switching element configured to connect the third data line and the output channel in response to a third switching signal, and
wherein the driving controller is configured to compensate for the dithering map based on the non-overlapping period for each of the first to sixth pixels.

15. The display device of claim 1, wherein, each of the first to fourth pixels includes a first color sub-pixel, a second color sub-pixel, and a third color sub-pixel.

16. An electronic device comprising:
a display panel including a first pixel connected to a first data line and a first gate line, a second pixel connected to the first data line and a second gate line, a third pixel connected to a second data line and the first gate line, and a fourth pixel connected to the second data line and the second gate line;
a data driver including an output channel providing a data voltage to each of the first data line and the second data line;
a gate driver configured to provide a first gate signal to the first gate line and a second gate signal to the second gate line;
a demultiplexer including a first switching element configured to connect the first data line and the output channel in response to a first switching signal and a second switching element configured to connect the second data line and the output channel in response to a second switching signal;
a driving controller configured to control the data driver, the gate driver, and the demultiplexer, and configured to compensate for input image data based on a dithering map having a first reference grayscale less than an input grayscale or a second reference grayscale greater than the input grayscale for each of the first to fourth pixels; and
a processor configured to control the driving controller, and
wherein the driving controller is configured to compensate for the input image data based on the dithering map which is compensated for according to a non-overlapping period of a turn-on period of a switching signal and a turn-on period of a gate signal for each of the first to fourth pixels.

17. The electronic device of claim 16, wherein a luminance of each of the first to fourth pixels is different according to a time length of the non-overlapping period.

18. The electronic device of claim 17, wherein, as the time length of the non-overlapping period is long, the luminance of each of the first to fourth pixels decreases.

19. The electronic device of claim 16, wherein, when a time length of a non-overlapping period of the first pixel is longer than a time length of a non-overlapping period of the third pixel and a time length of a non-overlapping period of the second pixel is longer than a time length of a non-overlapping period of the fourth pixel, the driving controller is configured to increase a reference grayscale of the first pixel and a reference grayscale of the second pixel.

20. The electronic device of claim 16, wherein, when a time length of a non-overlapping period of the first pixel is longer than a time length of a non-overlapping period of the third pixel and a time length of a non-overlapping period of the fourth pixel is longer than a time length of a non-overlapping period of the second pixel, the driving controller is configured to increase a reference grayscale of the first pixel and a reference grayscale of the fourth pixel.
